(19) United States
(12) Patent Application Publication
(10) Pub. No.: US 2024/0194947 A1
(43) Pub. Date: Jun. 13, 2024

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventor: Kentaro YOSHIMURA, Kyoto (JP)

(21) Appl. No.: 18/426,817

(22) Filed: Jan. 30, 2024

Related U.S. Application Data
(63) Continuation of application No. PCT/JP2022/025505, filed on Jun. 27, 2022.

(30) Foreign Application Priority Data
Aug. 12, 2021 (JP) 2021-131535

(51) Int. Cl. H01M 10/0567; H01M 4/02; H01M 10/0525

(52) U.S. Cl. CPC H01M 10/0567; H01M 10/0525; H01M 2004/027; H01M 2004/028; H01M 2300/0025

(57) ABSTRACT

A secondary battery includes a positive electrode, a negative electrode, and an electrolytic solution. The electrolytic solution includes a fluorine-containing compound. The fluorine-containing compound includes at least one of respective compounds represented by Formulae (1) to (22).

### CROSS REFERENCE TO RELATED APPLICATIONS

The present application is a continuation of PCT patent application no. PCT/JP2022/025505, filed on Jun. 27, 2022, which claims priority to Japanese patent application no. 2021-131535, filed on Aug. 12, 2021, the entire contents of which are incorporated herein by reference.

### BACKGROUND

The present application relates to an electrolytic solution for a secondary battery, and a secondary battery.

Various kinds of electronic equipment, including mobile phones, have been widely used. Such widespread use has promoted development of a secondary battery as a power source that is smaller in size and lighter in weight and allows for a higher energy density.

The secondary battery includes a positive electrode, a negative electrode, and an electrolytic solution (an electrolytic solution for a secondary battery). A configuration of the secondary battery has been considered in various ways. Specifically, to obtain a favorable charge and discharge cycle life characteristic, for example, a carbonic acid ester of an alcohol having a specific structure is included in an electrolytic solution.

### SUMMARY

The present application relates to an electrolytic solution for a secondary battery, and a secondary battery.

Although consideration has been given in various ways regarding a configuration of a secondary battery, a cyclability characteristic of the secondary battery is not sufficient yet. Accordingly, there is room for improvement in terms thereof.

It is therefore desirable to provide an electrolytic solution for a secondary battery and a secondary battery each of which makes it possible to achieve a superior cyclability characteristic.

An electrolytic solution for a secondary battery according to an embodiment of the present technology includes a fluorine-containing compound. The fluorine-containing compound includes at least one of respective compounds represented by Formulae (1) to (22).

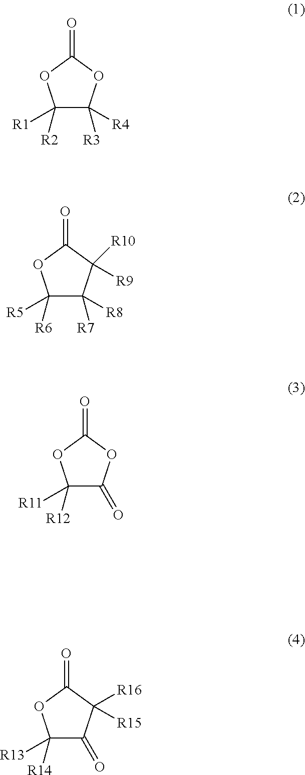

where:
each of R1 to R16 is any of hydrogen (H), fluorine (F), a hydrocarbon group, an oxygen-containing hydrocarbon group, a fluorinated hydrocarbon group, or a fluorine-containing group represented by Formula (30);
at least one of R1 to R4 is the fluorine-containing group;
at least one of R5 to R10 is the fluorine-containing group;
at least one of R11 or R12 is the fluorine-containing group; and
at least one of R13 to R16 is the fluorine-containing group.

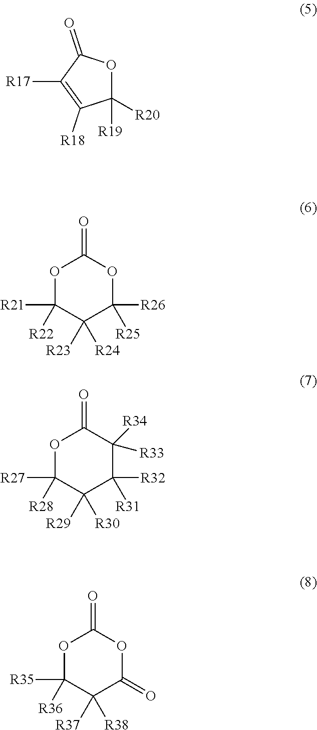

where:
each of R17 to R38 is any of hydrogen, fluorine, a hydrocarbon group, an oxygen-containing hydrocarbon group, a fluorinated hydrocarbon group, or the fluorine-containing group represented by Formula (30);
at least one of R17 to R20 is the fluorine-containing group;
at least one of R21 to R26 is the fluorine-containing group;
at least one of R27 to R34 is the fluorine-containing group; and
at least one of R35 to R38 is the fluorine-containing group.

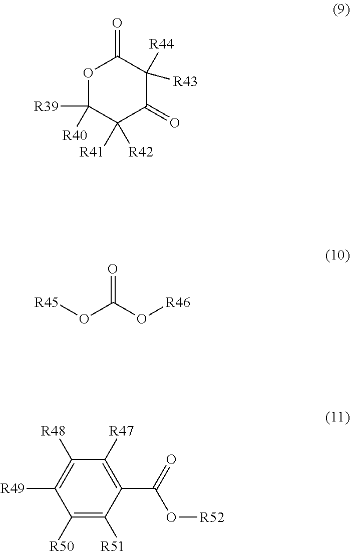

where:
each of R39 to R44 is any of hydrogen, fluorine, a hydrocarbon group, an oxygen-containing hydrocarbon group, a fluorinated hydrocarbon group, or the fluorine-containing group represented by Formula (30);
each of R45, R46, and R52 is any of a hydrocarbon group, a fluorinated hydrocarbon group, or the fluorine-containing group represented by Formula (30);
each of R47 to R51 is any of hydrogen, fluorine, an alkyl group, an alkoxy group, or a fluorinated alkyl group;
at least one of R39 to R44 is the fluorine-containing group;
at least one of R45 or R46 is the fluorine-containing group; and
at least one of R47 to R51 is a trifluoromethyl group.

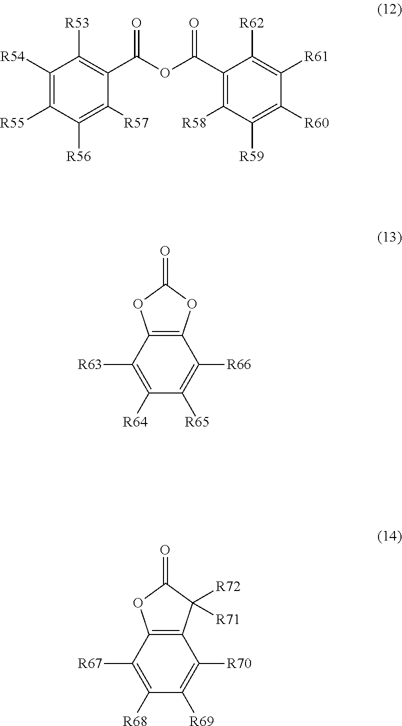

where:
each of R53 to R70 is any of hydrogen, fluorine, an alkyl group, an alkoxy group, or a fluorinated alkyl group;
each of R71 and R72 is any of hydrogen, fluorine, a hydrocarbon group, an oxygen-containing hydrocarbon group, a fluorinated hydrocarbon group, or the fluorine-containing group represented by Formula (30);
at least one of R53 to R62 is a trifluoromethyl group;
at least one of R63 to R66 is a trifluoromethyl group; and
at least one of R67 to R70 is a trifluoromethyl group.

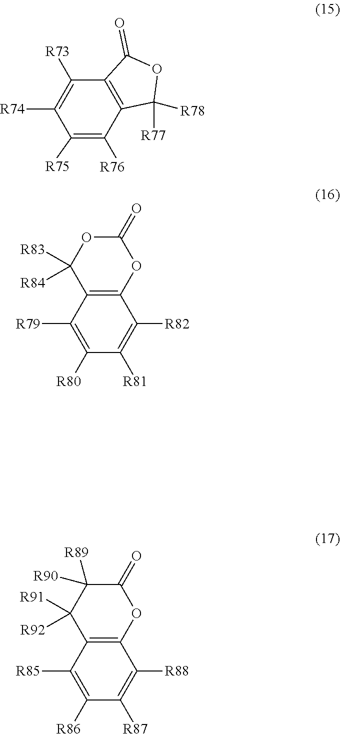

where:
each of R73 to R76, R79 to R82, and R85 to R88 is any of hydrogen, fluorine, an alkyl group, an alkoxy group, or a fluorinated alkyl group;
each of R77, R78, R83, R84, and R89 to R92 is any of hydrogen, fluorine, a hydrocarbon group, an oxygen-containing hydrocarbon group, a fluorinated hydrocarbon group, or the fluorine-containing group represented by Formula (30);
at least one of R73 to R76 is a trifluoromethyl group;
at least one of R79 to R82 is a trifluoromethyl group; and
at least one of R85 to R88 is a trifluoromethyl group.

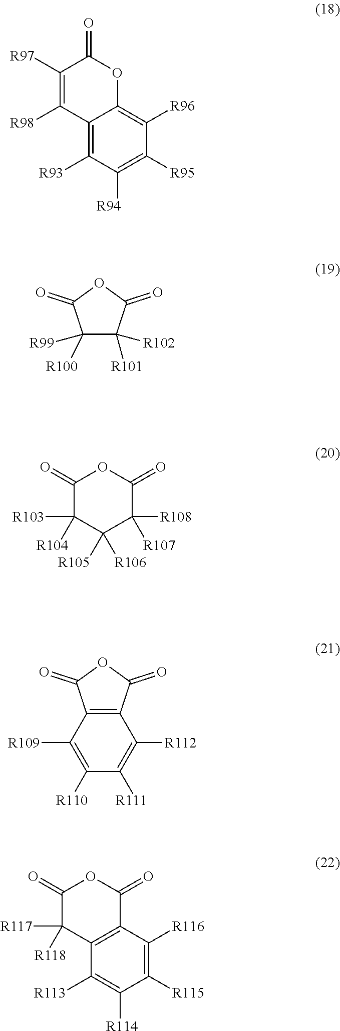

where:
each of R93 to R96 and R109 to R116 is any of hydrogen, fluorine, an alkyl group, an alkoxy group, or a fluorinated alkyl group;
each of R97 to R108, R117, and R118 is any of hydrogen, fluorine, a hydrocarbon group, an oxygen-containing hydrocarbon group, a fluorinated hydrocarbon group, or the fluorine-containing group represented by Formula (30);
at least one of R93 to R96 is a trifluoromethyl group;
at least one of R99 to R102 is the fluorine-containing group;
at least one of R103 to R108 is the fluorine-containing group;
at least one of R109 to R112 is a trifluoromethyl group; and
at least one of R113 to R116 is a trifluoromethyl group.

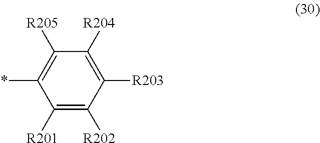

where:
each of R201 to R205 is any of hydrogen or a trifluoromethyl group;
an asterisk (*) is a dangling bond; and
at least one of R201 to R205 is a trifluoromethyl group.

A secondary battery according to an embodiment of the present technology includes a positive electrode, a negative electrode, and an electrolytic solution. The electrolytic solution has a configuration similar to the configuration of the electrolytic solution for a secondary battery according to the embodiment of the technology described herein.

According to an embodiment, the electrolytic solution for a secondary battery includes the fluorine-containing compound. Accordingly, it is possible to achieve a superior cyclability characteristic.

Note that effects of the present technology are not necessarily limited to those described herein and may include any suitable effect, including described below, in relation to the present technology.

### BRIEF DESCRIPTION OF THE FIGURES

FIG. 1 is a sectional view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

The present technology will be described below in further detail including the drawings according to an embodiment.

A description is given first of an electrolytic solution for a secondary battery (hereinafter simply referred to as an “electrolytic solution”) according to an embodiment of the present technology.

The electrolytic solution is to be used in a secondary battery, which is an electrochemical device. However, the electrolytic solution may be used in electrochemical devices other than a secondary battery. Other electrochemical devices are not particularly limited in kind, and specific examples thereof include a capacitor.

The electrolytic solution includes a fluorine-containing compound. The fluorine-containing compound includes any one or more of respective compounds represented by Formulae (1) to (22).

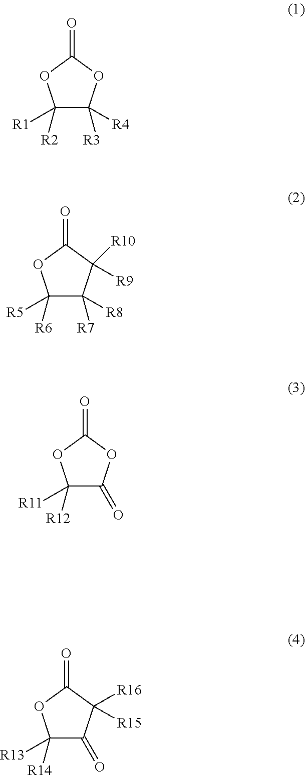

where:
each of R1 to R16 is any of hydrogen, fluorine, a hydrocarbon group, an oxygen-containing hydrocarbon group, a fluorinated hydrocarbon group, or a fluorine-containing group represented by Formula (30);
at least one of R1 to R4 is the fluorine-containing group;
at least one of R5 to R10 is the fluorine-containing group;
at least one of R11 or R12 is the fluorine-containing group; and
at least one of R13 to R16 is the fluorine-containing group.

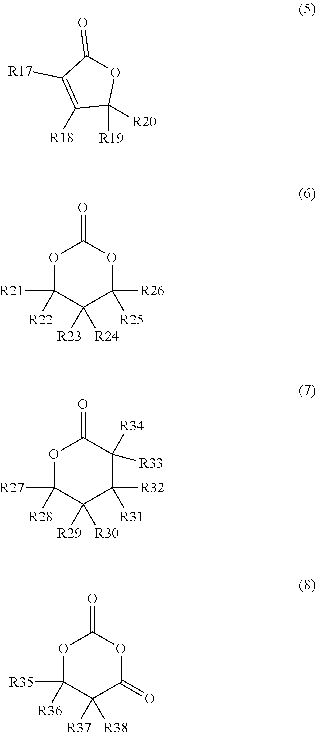

where:
each of R17 to R38 is any of hydrogen, fluorine, a hydrocarbon group, an oxygen-containing hydrocarbon group, a fluorinated hydrocarbon group, or the fluorine-containing group represented by Formula (30);
at least one of R17 to R20 is the fluorine-containing group;
at least one of R21 to R26 is the fluorine-containing group;
at least one of R27 to R34 is the fluorine-containing group; and
at least one of R35 to R38 is the fluorine-containing group.

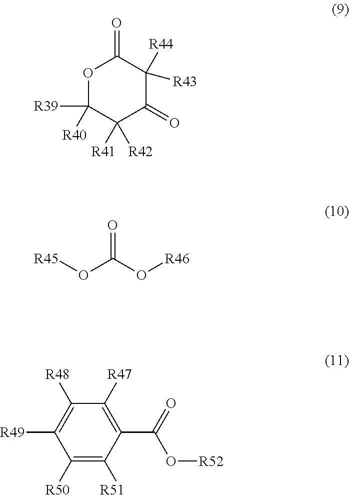

where:
each of R39 to R44 is any of hydrogen, fluorine, a hydrocarbon group, an oxygen-containing hydrocarbon group, a fluorinated hydrocarbon group, or the fluorine-containing group represented by Formula (30);
each of R45, R46, and R52 is any of a hydrocarbon group, a fluorinated hydrocarbon group, or the fluorine-containing group represented by Formula (30);
each of R47 to R51 is any of hydrogen, fluorine, an alkyl group, an alkoxy group, or a fluorinated alkyl group;
at least one of R39 to R44 is the fluorine-containing group;
at least one of R45 or R46 is the fluorine-containing group; and
at least one of R47 to R51 is a trifluoromethyl group.

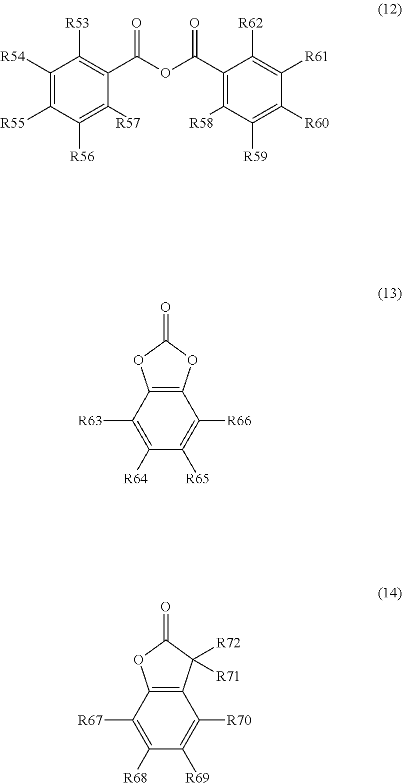

where:
each of R53 to R70 is any of hydrogen, fluorine, an alkyl group, an alkoxy group, or a fluorinated alkyl group;
each of R71 and R72 is any of hydrogen, fluorine, a hydrocarbon group, an oxygen-containing hydrocarbon group, a fluorinated hydrocarbon group, or the fluorine-containing group represented by Formula (30);
at least one of R53 to R62 is a trifluoromethyl group;
at least one of R63 to R66 is a trifluoromethyl group; and
at least one of R67 to R70 is a trifluoromethyl group.

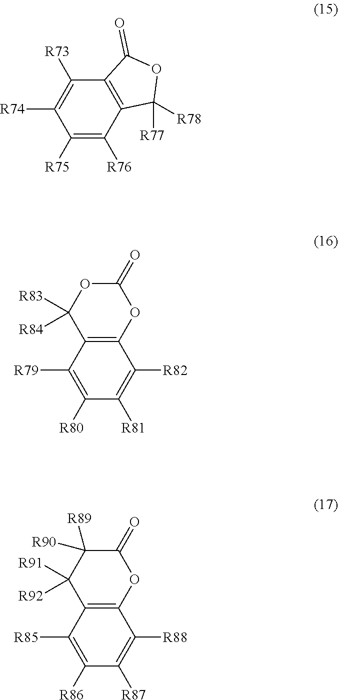

where:
each of R73 to R76, R79 to R82, and R85 to R88 is any of hydrogen, fluorine, an alkyl group, an alkoxy group, or a fluorinated alkyl group;
each of R77, R78, R83, R84, and R89 to R92 is any of hydrogen, fluorine, a hydrocarbon group, an oxygen-containing hydrocarbon group, a fluorinated hydrocarbon group, or the fluorine-containing group represented by Formula (30);
at least one of R73 to R76 is a trifluoromethyl group;
at least one of R79 to R82 is a trifluoromethyl group; and
at least one of R85 to R88 is a trifluoromethyl group.

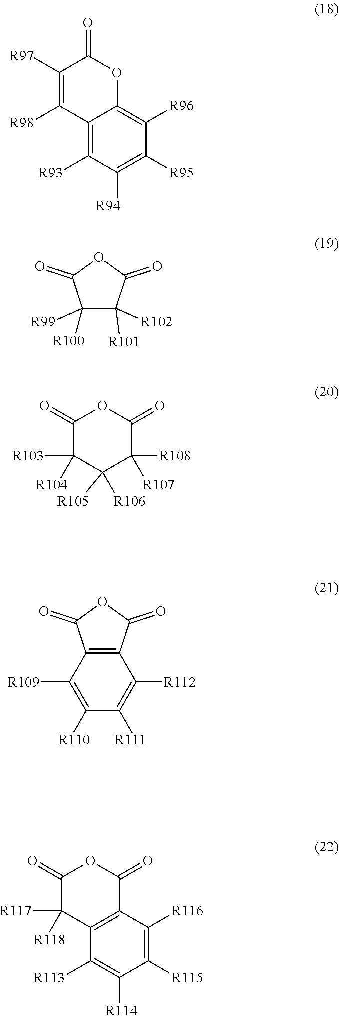

where:
each of R93 to R96 and R109 to R116 is any of hydrogen, fluorine, an alkyl group, an alkoxy group, or a fluorinated alkyl group;
each of R97 to R108, R117, and R118 is any of hydrogen, fluorine, a hydrocarbon group, an oxygen-containing hydrocarbon group, a fluorinated hydrocarbon group, or the fluorine-containing group represented by Formula (30);
at least one of R93 to R96 is a trifluoromethyl group;
at least one of R99 to R102 is the fluorine-containing group;
at least one of R103 to R108 is the fluorine-containing group;
at least one of R109 to R112 is a trifluoromethyl group; and
at least one of R113 to R116 is a trifluoromethyl group.

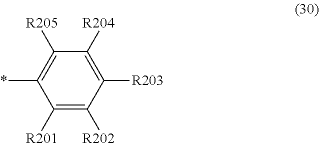

where:
each of R201 to R205 is any of hydrogen or a trifluoromethyl group; an asterisk (*) is a dangling bond; and
at least one of R201 to R205 is a trifluoromethyl group.

The fluorine-containing compound is a compound including fluorine, as is apparent from Formulae (1) to (22). More specifically, the fluorine-containing compound is a compound that includes an aromatic ring (a benzene ring) having one or more trifluoromethyl groups (—CF₃) introduced therein.

A reason why the electrolytic solution includes the fluorine-containing compound is that, when a solvent to be described later decomposes on a surface of an electrode upon charging and discharging of the secondary battery including the electrolytic solution, the benzene ring having the one or more trifluoromethyl groups introduced therein also decomposes together, which forms a favorable film derived from the fluorine-containing compound on the surface of the electrode. The film has an electrochemically stable property, and thus serves as a protective film on the surface of the electrode.

This suppresses a decomposition reaction of the electrolytic solution upon charging and discharging, which reduces a decrease in a discharge capacity even upon repeated charging and discharging. In this case, particularly, the film derived from the fluorine-containing compound has superior electrochemical durability, which effectively reduces a decrease in the discharge capacity even if the secondary battery is charged and discharged in a high temperature environment.

The 22 compounds represented by Formulae (1) to (22) are described in detail below. Note that only one of the respective compounds represented by Formulae (1) to (22) may be used, or two or more of the respective compounds represented by Formulae (1) to (22) may be used.

### (First Fluorine-Containing Compound)

The compound represented by Formula (1) is a first fluorine-containing compound having a cyclic structure. Each of R1 to R4 is not particularly limited as long as each of R1 to R4 is any of hydrogen, fluorine, a hydrocarbon group, an oxygen-containing hydrocarbon group, a fluorinated hydrocarbon group, or the fluorine-containing group; however, one or more of R1 to R4 are each the fluorine-containing group. Thus, the first fluorine-containing compound includes a benzene ring having a trifluoromethyl group introduced therein, and the number of the benzene rings each having the trifluoromethyl group introduced therein is one or more.

The hydrocarbon group is a monovalent group including carbon and hydrogen. The hydrocarbon group may have: a straight-chain structure; or a branched structure having one or more side chains. The hydrocarbon group may include a carbon-carbon double bond (>C═C<) or a carbon-carbon triple bond (—C≡C—).

In particular, the hydrocarbon group is preferably any of an alkyl group, an alkenyl group, or an alkynyl group. A reason for this is that this secures solubility and compatibility of the first fluorine-containing compound.

Specific examples of the alkyl group include a methyl group, an ethyl group, and a propyl group. Specific examples of the alkenyl group include a vinyl group, an allyl group, a 2-propenyl group, and a propa-2-en-1-yl group. Specific examples of the alkynyl group include an ethynyl group, a propargyl group, a 2-propynyl group, and a propa-2-yn-1-yl group.

Carbon number of each of the alkyl group, the alkenyl group, and the alkynyl group is not particularly limited, but is preferably less than or equal to 3 in particular. Specifically, the carbon number of the alkyl group is preferably within a range from 1 to 3 both inclusive, and the carbon number of each of the alkenyl group and the alkynyl group is preferably 2 or 3. A reason for this is that this further improves the solubility and the compatibility of the first fluorine-containing compound.

The oxygen-containing hydrocarbon group is a monovalent group including carbon, hydrogen, and oxygen. The oxygen-containing hydrocarbon group may have: a straight-chain structure; or a branched structure having one or more side chains.

In particular, the hydrocarbon group is preferably an alkoxy group. A reason for this is that this secures the solubility and the compatibility of the first fluorine-containing compound. Specific examples of the alkoxy group include a methoxy group, an ethoxy group, and a propoxy group.

Carbon number of the alkoxy group is not particularly limited, but is preferably less than or equal to 3 in particular. A reason for this is that this further improves the solubility and the compatibility of the first fluorine-containing compound.

The fluorinated hydrocarbon group is a group resulting from substituting one or more hydrogens of the hydrocarbon group (the alkyl group, the alkenyl group, or the alkynyl group) described above with one or more fluorines.

Note that the fluorine-containing group is a phenyl group having a trifluoromethyl group introduced therein, as represented by Formula (30). Each of R201 to R205 is not particularly limited in kind as long as each of R201 to R205 is any of hydrogen or a trifluoromethyl group; however, one or more of R201 to R205 are each a trifluoromethyl group. Thus, the fluorine-containing group includes one or more trifluoromethyl groups.

Specific examples of the first fluorine-containing compound include respective compounds represented by Formulae (1-1) to (1-11).

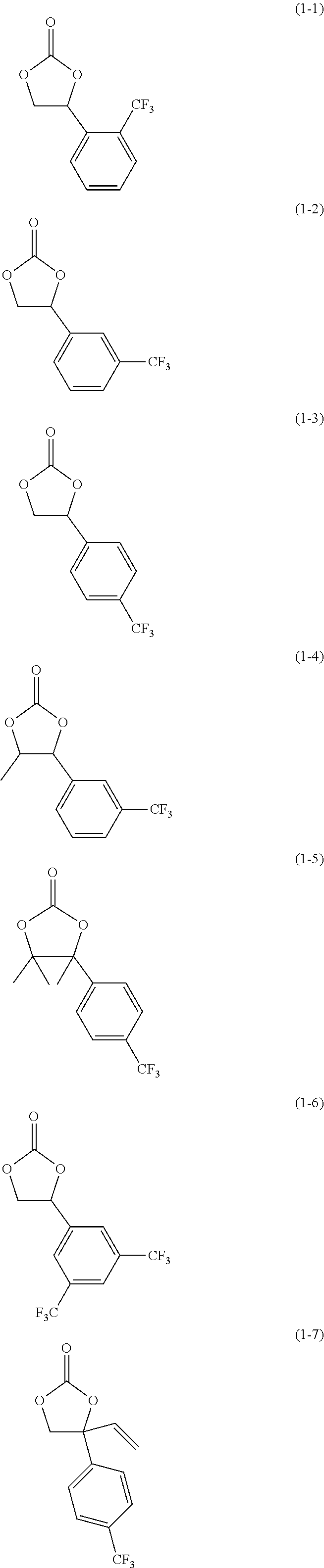

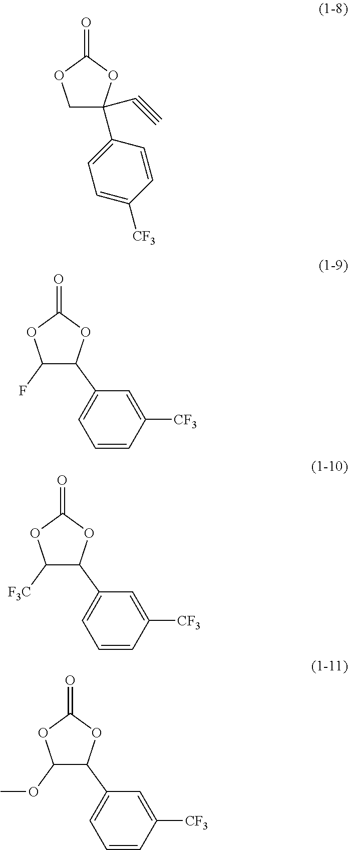

The compound represented by Formula (2) is a second fluorine-containing compound having a cyclic structure. Details of each of R5 to R10 are similar to those of each of R1 to R4. Note that one or more of R5 to R10 are each the fluorine-containing group. Thus, the second fluorine-containing compound includes a benzene ring having a trifluoromethyl group introduced therein, and the number of the benzene rings each having the trifluoromethyl group introduced therein is one or more.

Specific examples of the second fluorine-containing compound include respective compounds represented by Formulae (2-1) to (2-15).

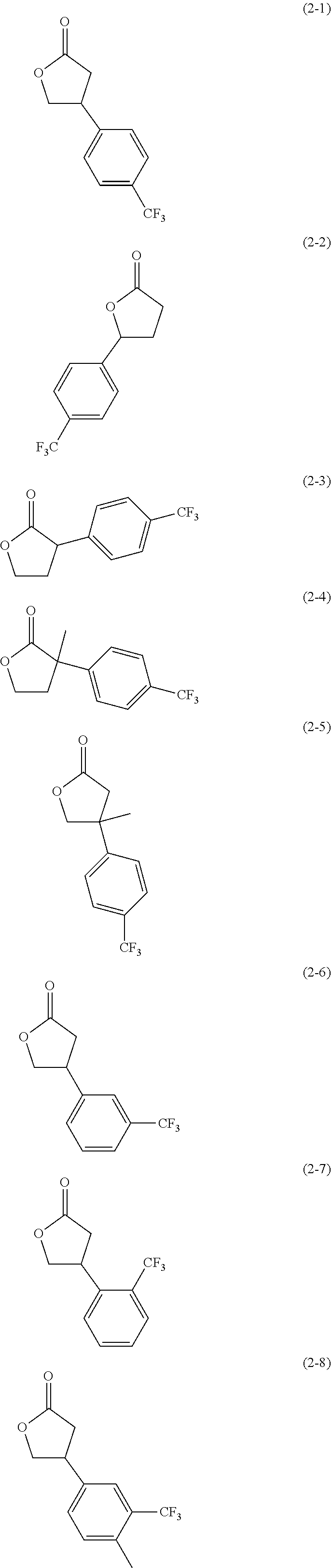

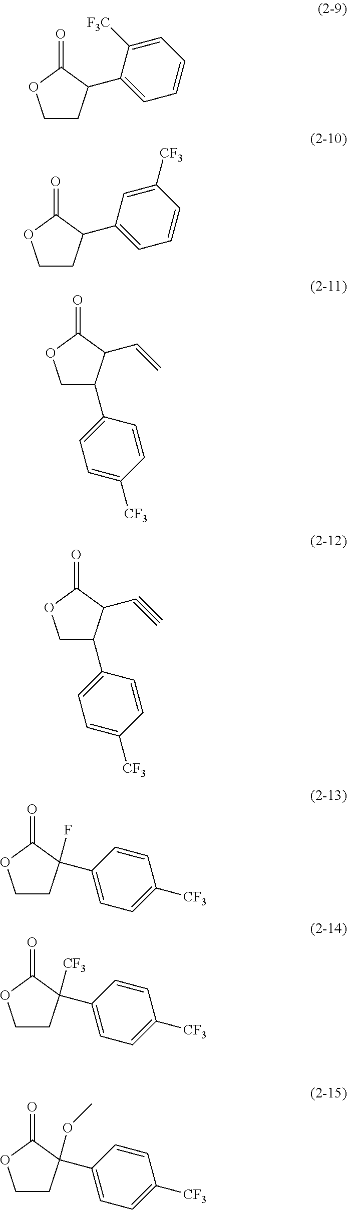

The compound represented by Formula (3) is a third fluorine-containing compound having a cyclic structure. Details of each of R11 and R12 are similar to those of each of R1 to R4. Note that R11, R12, or each of R11 and R12 is the fluorine-containing group. Thus, the third fluorine-containing compound includes a benzene ring having a trifluoromethyl group introduced therein, and the number of the benzene rings each having the trifluoromethyl group introduced therein is one or more.

Specific examples of the third fluorine-containing compound include respective compounds represented by Formulae (3-1) to (3-9).

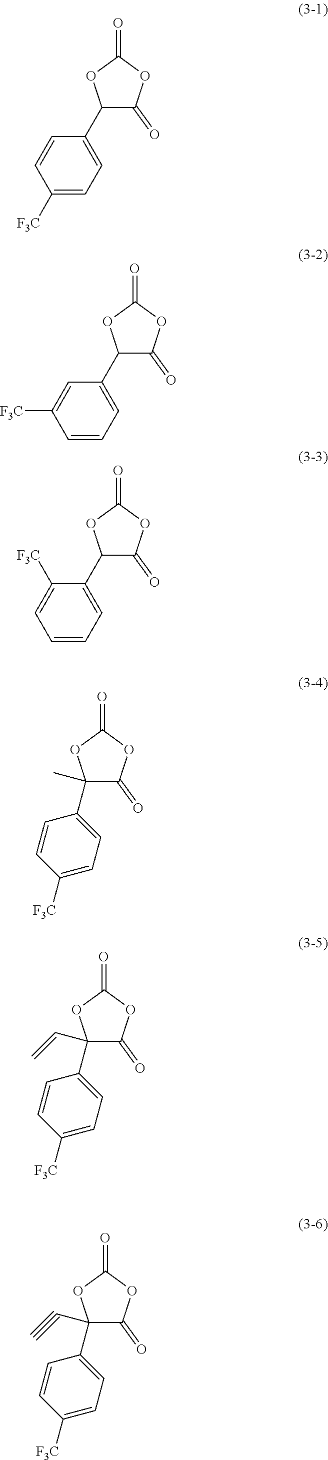

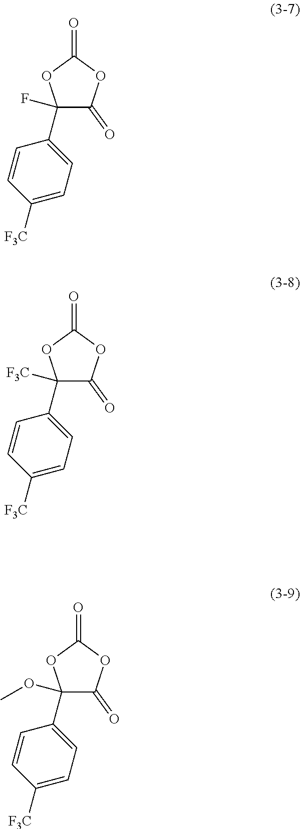 [SMILES: O=C1OC(=O)C(F)(c2ccc(C(F)(F)F)cc2)O1 ; O=C1OC(=O)C(c2ccc(C(F)(F)F)cc2)(C(F)(F)F)O1 ; COC1(c2ccc(C(F)(F)F)cc2)OC(=O)OC1=O]

The compound represented by Formula (4) is a fourth fluorine-containing compound having a cyclic structure. Details of each of R13 to R16 are similar to those of each of R1 to R4. Note that one or more of R13 to R16 are each the fluorine-containing group. Thus, the fourth fluorine-containing compound includes a benzene ring having a trifluoromethyl group introduced therein, and the number of the benzene rings each having the trifluoromethyl group introduced therein is one or more.

Specific examples of the fourth fluorine-containing compound include respective compounds represented by Formulae (4-1) to (4-9).

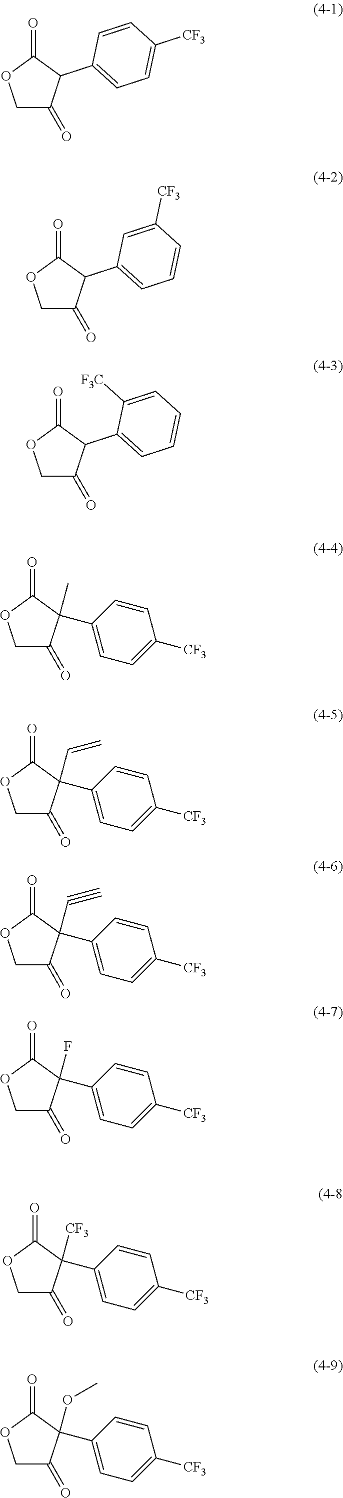

The compound represented by Formula (5) is a fifth fluorine-containing compound having a cyclic structure. Details of each of R17 to R20 are similar to those of each of R1 to R4. Note that one or more of R17 to R20 are each the fluorine-containing group. Thus, the fifth fluorine-containing compound includes a benzene ring having a trifluoromethyl group introduced therein, and the number of the benzene rings each having the trifluoromethyl group introduced therein is one or more.

Specific examples of the fifth fluorine-containing compound include respective compounds represented by Formulae (5-1) to (5-9).

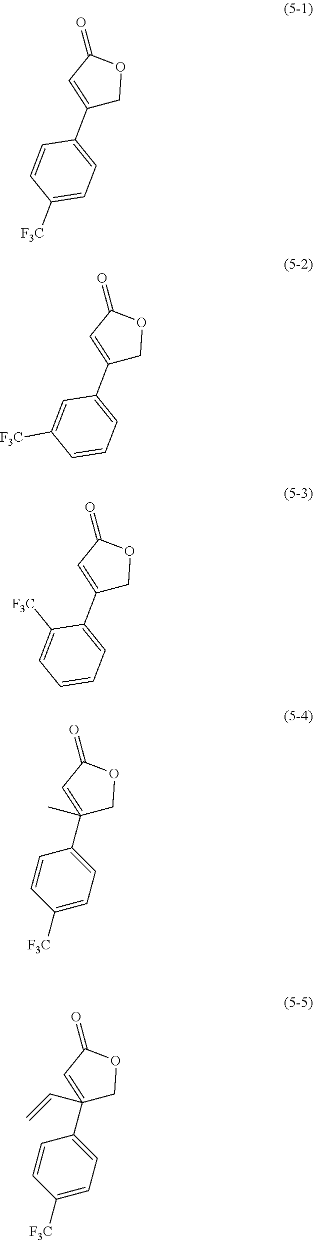

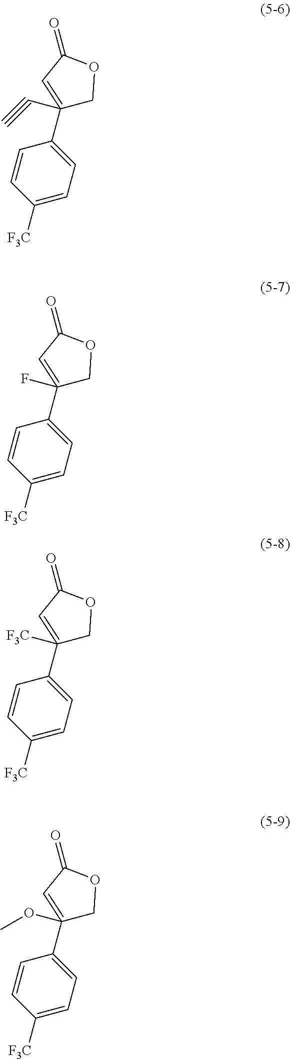

The compound represented by Formula (6) is a sixth fluorine-containing compound having a cyclic structure. Details of each of R21 to R26 are similar to those of each of R1 to R4. Note that one or more of R21 to R26 are each the fluorine-containing group. Thus, the sixth fluorine-containing compound includes a benzene ring having a trifluoromethyl group introduced therein, and the number of the benzene rings each having the trifluoromethyl group introduced therein is one or more.

Specific examples of the sixth fluorine-containing compound include respective compounds represented by Formulae (6-1) to (6-11).

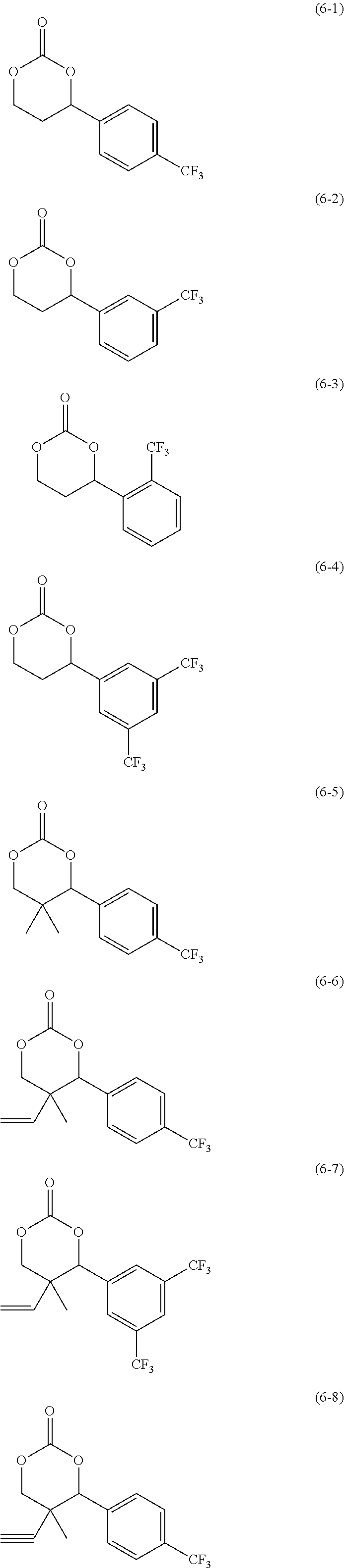

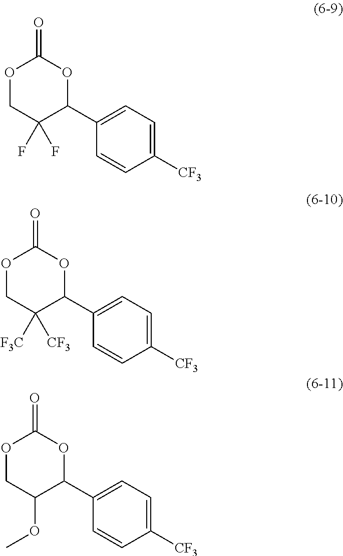 [SMILES: O=C1OCC(F)(F)C(c2ccc(C(F)(F)F)cc2)O1 ; O=C1OCC(C(F)(F)F)(C(F)(F)F)C(c2ccc(C(F)(F)F)cc2)O1 ; COC1COC(=O)OC1c1ccc(C(F)(F)F)cc1]

The compound represented by Formula (7) is a seventh fluorine-containing compound having a cyclic structure. Details of each of R27 to R34 are similar to those of each of R1 to R4. Note that one or more of R27 to R34 are each the fluorine-containing group. Thus, the seventh fluorine-containing compound includes a benzene ring having a trifluoromethyl group introduced therein, and the number of the benzene rings each having the trifluoromethyl group introduced therein is one or more.

Specific examples of the seventh fluorine-containing compound include respective compounds represented by Formulae (7-1) to (7-12).

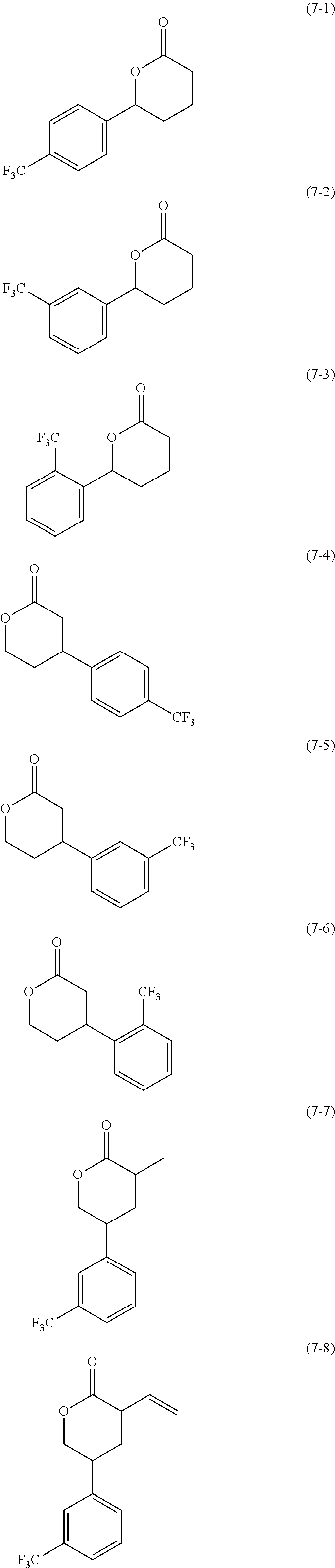

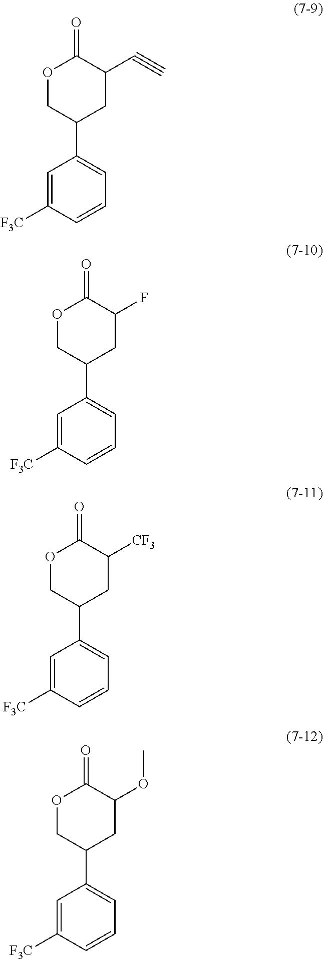

The compound represented by Formula (8) is an eighth fluorine-containing compound having a cyclic structure. Details of each of R35 to R38 are similar to those of each of R1 to R4. Note that one or more of R3 5 to R38 are each the fluorine-containing group. Thus, the eighth fluorine-containing compound includes a benzene ring having a trifluoromethyl group introduced therein, and the number of the benzene rings each having the trifluoromethyl group introduced therein is one or more.

Specific examples of the eighth fluorine-containing compound include respective compounds represented by Formulae (8-1) to (8-9).

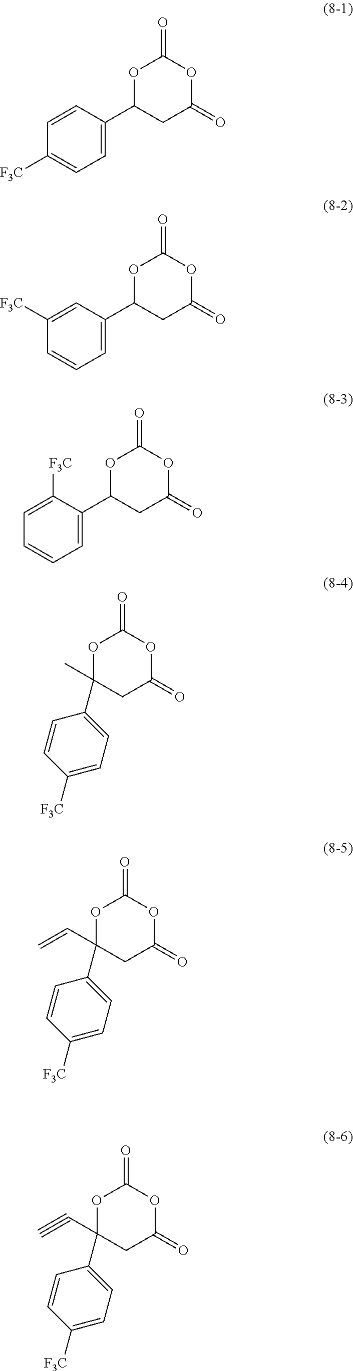 [SMILES: O=C1CC(c2ccc(C(F)(F)F)cc2)OC(=O)O1 ; O=C1CC(c2cccc(C(F)(F)F)c2)OC(=O)O1 ; O=C1CC(c2ccccc2C(F)(F)F)OC(=O)O1 ; CC1(c2ccc(C(F)(F)F)cc2)CC(=O)OC(=O)O1 ; C=CC1(c2ccc(C(F)(F)F)cc2)CC(=O)OC(=O)O1 ; C#CC1(c2ccc(C(F)(F)F)cc2)CC(=O)OC(=O)O1]

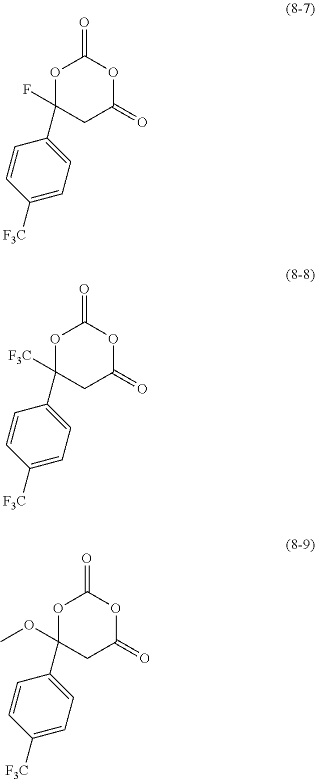 [SMILES: O=C1CC(F)(c2ccc(C(F)(F)F)cc2)OC(=O)O1 ; O=C1CC(c2ccc(C(F)(F)F)cc2)(C(F)(F)F)OC(=O)O1 ; COC1(c2ccc(C(F)(F)F)cc2)CC(=O)OC(=O)O1]

The compound represented by Formula (9) is a ninth fluorine-containing compound having a cyclic structure. Details of each of R39 to R44 are similar to those of each of R1 to R4. Note that one or more of R39 to R44 are each the fluorine-containing group. Thus, the ninth fluorine-containing compound includes a benzene ring having a trifluoromethyl group introduced therein, and the number of the benzene rings each having the trifluoromethyl group introduced therein is one or more.

Specific examples of the ninth fluorine-containing compound include respective compounds represented by Formulae (9-1) to (9-9).

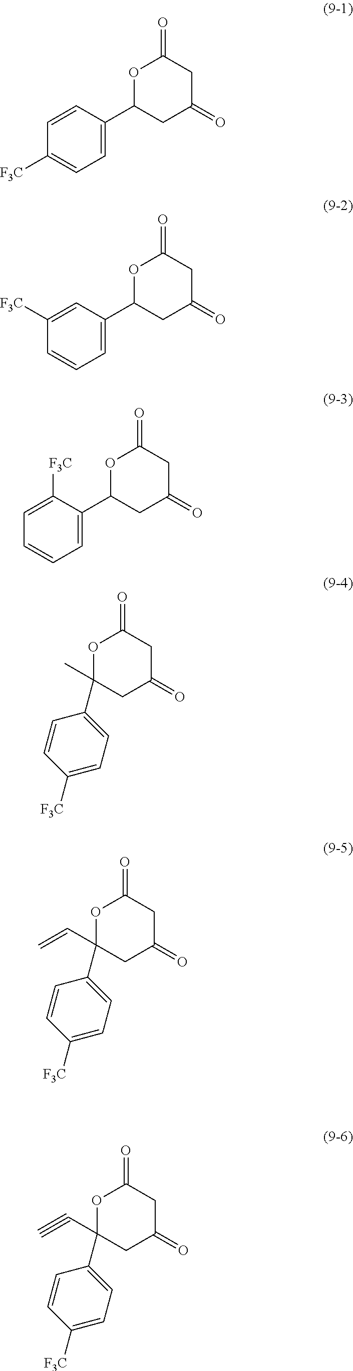 [SMILES: O=C1CC(=O)OC(c2ccc(C(F)(F)F)cc2)C1 ; O=C1CC(=O)OC(c2cccc(C(F)(F)F)c2)C1 ; O=C1CC(=O)OC(c2ccccc2C(F)(F)F)C1 ; CC1(c2ccc(C(F)(F)F)cc2)CC(=O)CC(=O)O1 ; C=CC1(c2ccc(C(F)(F)F)cc2)CC(=O)CC(=O)O1 ; C#CC1(c2ccc(C(F)(F)F)cc2)CC(=O)CC(=O)O1]

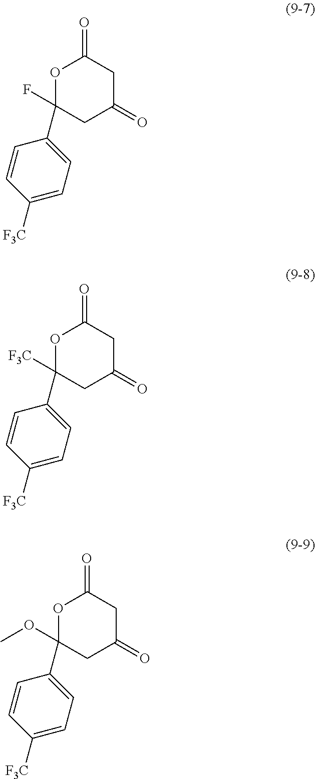 [SMILES: O=C1CC(=O)OC(F)(c2ccc(C(F)(F)F)cc2)C1 ; O=C1CC(=O)OC(c2ccc(C(F)(F)F)cc2)(C(F)(F)F)C1 ; COC1(c2ccc(C(F)(F)F)cc2)CC(=O)CC(=O)O1]

The compound represented by Formula (10) is a 10th fluorine-containing compound having a chain structure. Details of each of R45 and R46 are similar to those of each of R1 to R4, except that hydrogen, fluorine, and an oxygen-containing hydrocarbon group are excluded. Note that R45, R46, or each of R45 and R46 is the fluorine-containing group. Thus, the 10th fluorine-containing compound includes a benzene ring having a trifluoromethyl group introduced therein, and the number of the benzene rings each having the trifluoromethyl group introduced therein is one or more.

Specific examples of the 10th fluorine-containing compound include respective compounds represented by Formulae (10-1) to (10-10).

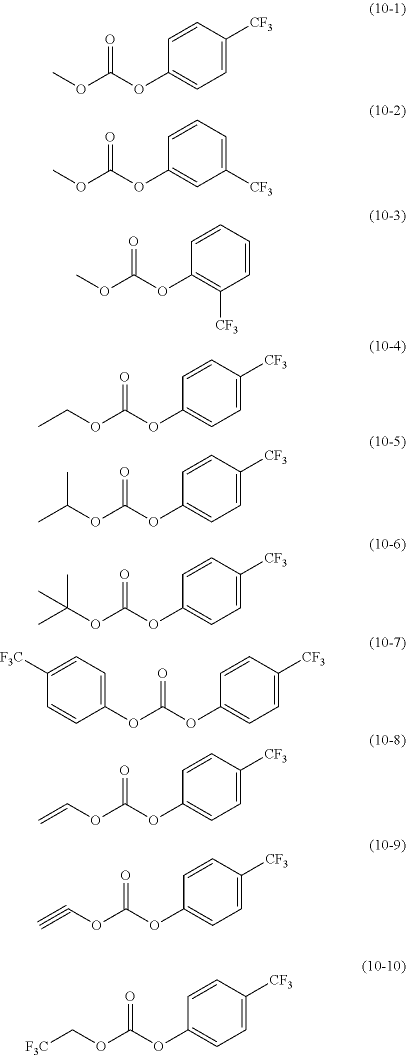

The compound represented by Formula (11) is an 11th fluorine-containing compound having a cyclic structure. Each of R47 to R51 is not particularly limited as long as each of R47 to R51 is any of hydrogen, fluorine, an alkyl group, an alkoxy group, or a fluorinated alkyl; however, one or more of R47 to R51 are each a trifluoromethyl group. Details of R52 are similar to those of each of R45 and R46. Thus, the 11th fluorine-containing compound includes a benzene ring having a trifluoromethyl group introduced therein, and the number of the benzene rings each having the trifluoromethyl group introduced therein is one or more.

Details of each of the alkyl group and the alkoxy group are as described above. Further, details of the carbon number of each of the alkyl group and the alkoxy group are as described above. The carbon number of each of the alkyl group and the alkoxy group is preferably less than or equal to 3, more specifically, within the range from 1 to 3 both inclusive, as described above. A reason for this is that this further improves solubility and compatibility of the 11th fluorine-containing compound.

The fluorinated alkyl group is a group resulting from substituting one or more hydrogens of the alkyl group described above with one or more fluorines. Details of the carbon number of the alkyl group, which determines the carbon number of the fluorinated alkyl group, are as described above.

Specific examples of the 11th fluorine-containing compound include respective compounds represented by Formulae (11-1) to (11-11).

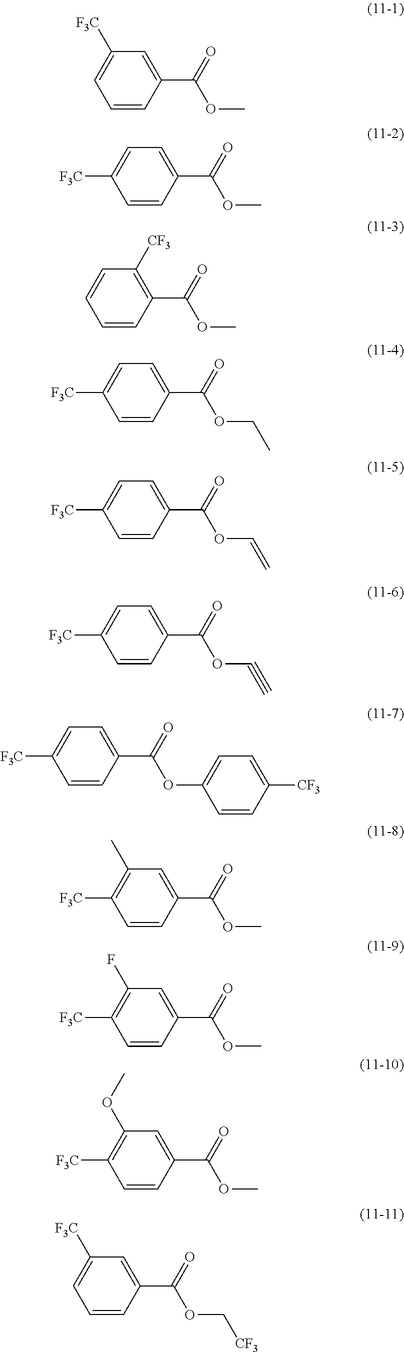

The compound represented by Formula (12) is a 12th fluorine-containing compound having a cyclic structure. Details of each of R53 to R62 are similar to those of each of R47 to R51. Note that one or more of R53 to R62 are each a trifluoromethyl group. Thus, the 12th fluorine-containing compound includes a benzene ring having a trifluoromethyl group introduced therein, and the number of the benzene rings each having the trifluoromethyl group introduced therein is one or more.

Specific examples of the 12th fluorine-containing compound include respective compounds represented by Formulae (12-1) to (12-6).

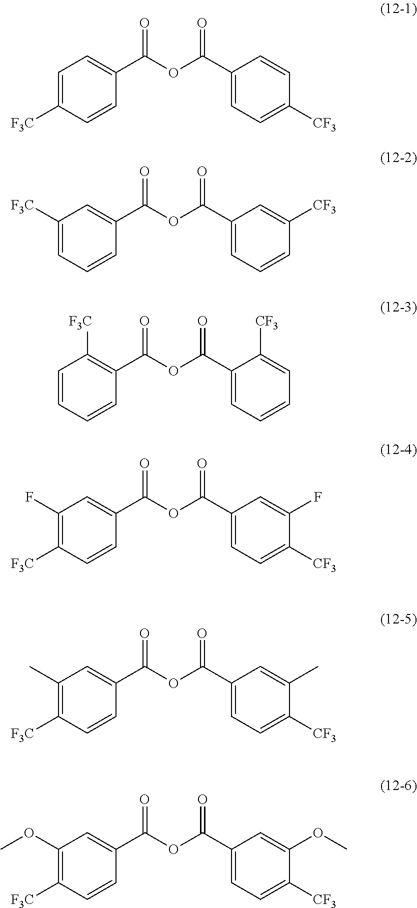

The compound represented by Formula (13) is a 13th fluorine-containing compound having a cyclic structure. Details of each of R63 to R66 are similar to those of each of R47 to R51. Note that one or more of R63 to R66 are each a trifluoromethyl group. Thus, the 13th fluorine-containing compound includes a benzene ring having a trifluoromethyl group introduced therein, and the number of the benzene rings each having the trifluoromethyl group introduced therein is one or more.

Specific examples of the 13th fluorine-containing compound include respective compounds represented by Formulae (13-1) to (13-6).

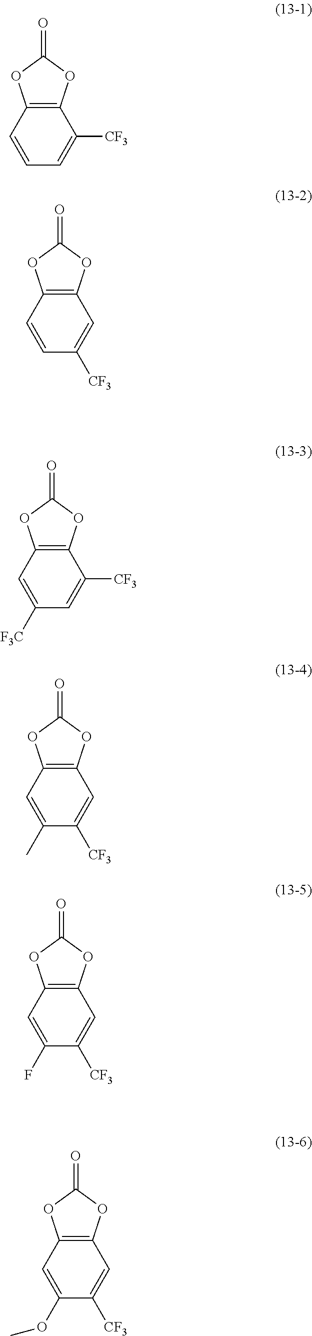

The compound represented by Formula (14) is a 14th fluorine-containing compound having a cyclic structure. Details of each of R67 to R70 are similar to those of each of R47 to R51. Details of each of R71 and R72 are similar to those of each of R1 to R4. Note that one or more of R67 to R70 are each a trifluoromethyl group. Thus, the 14th fluorine-containing compound includes a benzene ring having a trifluoromethyl group introduced therein, and the number of the benzene rings each having the trifluoromethyl group introduced therein is one or more.

Specific examples of the 14th fluorine-containing compound include respective compounds represented by Formulae (14-1) to (14-13).

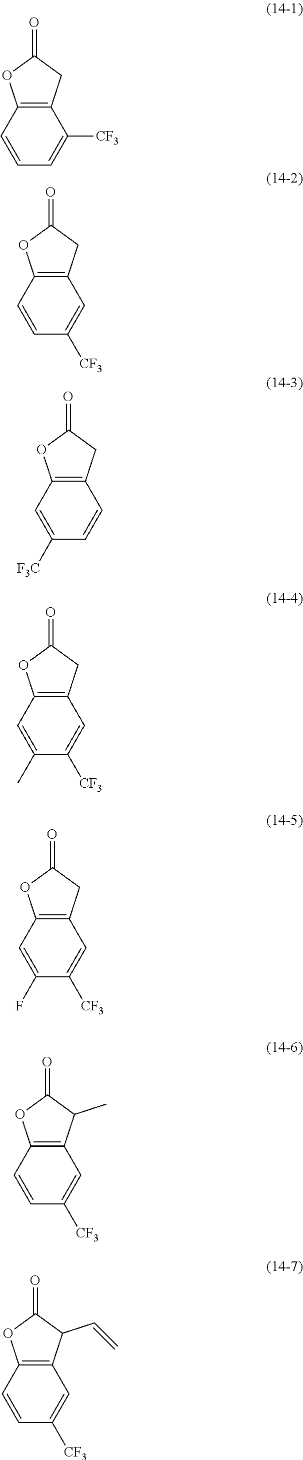

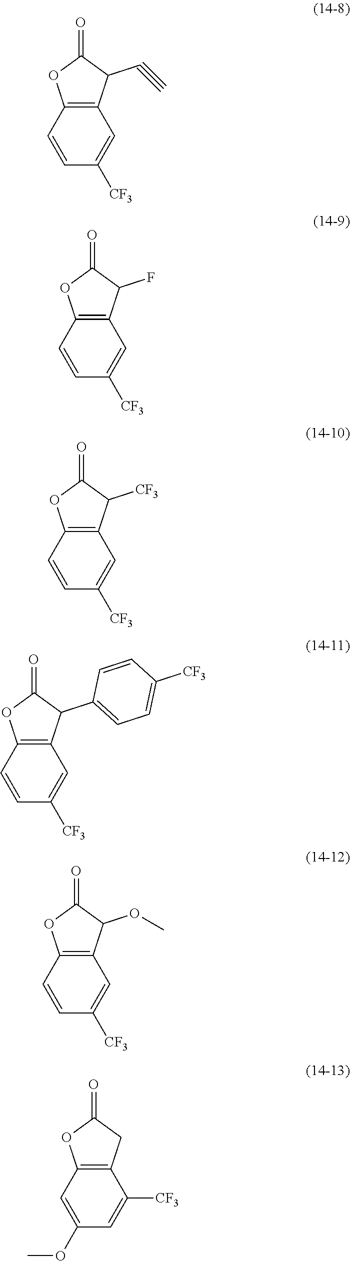

The compound represented by Formula (15) is a 15th fluorine-containing compound having a cyclic structure. Details of each of R73 to R76 are similar to those of each of R47 to R51. Details of each of R77 and R78 are similar to those of each of R1 to R4. Note that one or more of R73 to R76 are each a trifluoromethyl group. Thus, the 15th fluorine-containing compound includes a benzene ring having a trifluoromethyl group introduced therein, and the number of the benzene rings each having the trifluoromethyl group introduced therein is one or more.

Specific examples of the 15th fluorine-containing compound include respective compounds represented by Formulae (15-1) to (15-14).

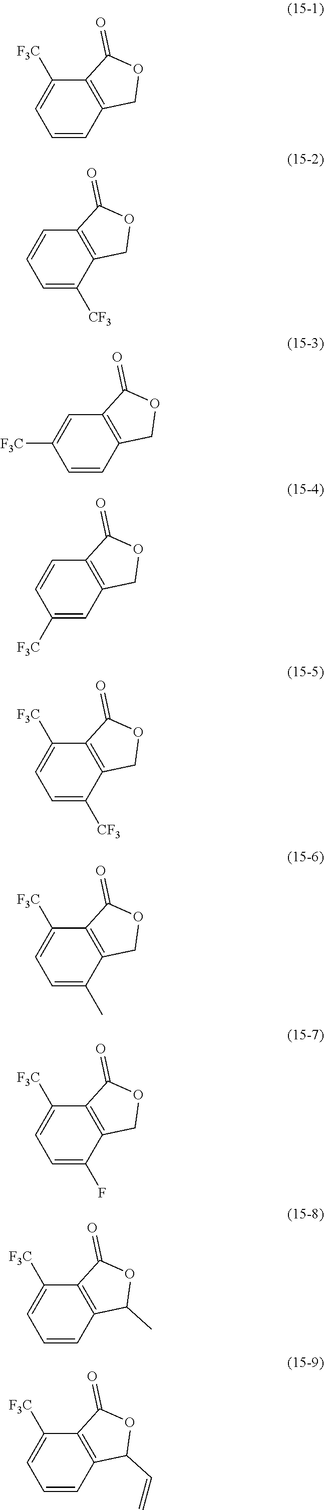

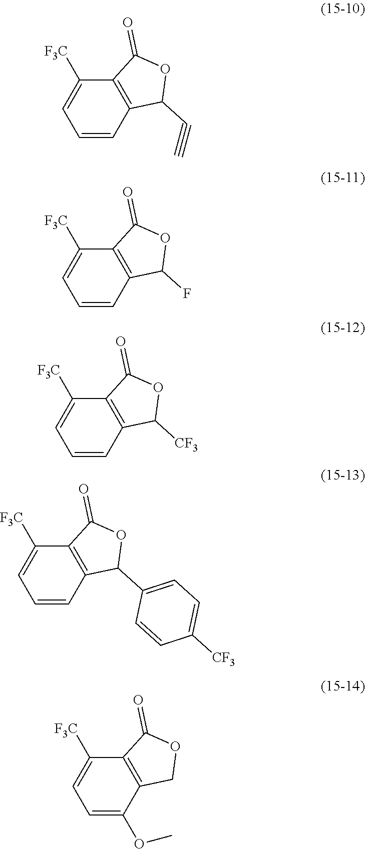

The compound represented by Formula (16) is a 16th fluorine-containing compound having a cyclic structure. Details of each of R79 to R82 are similar to those of each of R47 to R51. Details of each of R83 and R84 are similar to those of each of R1 to R4. Note that one or more of R79 to R82 are each a trifluoromethyl group. Thus, the 16th fluorine-containing compound includes a benzene ring having a trifluoromethyl group introduced therein, and the number of the benzene rings each having the trifluoromethyl group introduced therein is one or more.

Specific examples of the 16th fluorine-containing compound include respective compounds represented by Formulae (16-1) to (16-15).

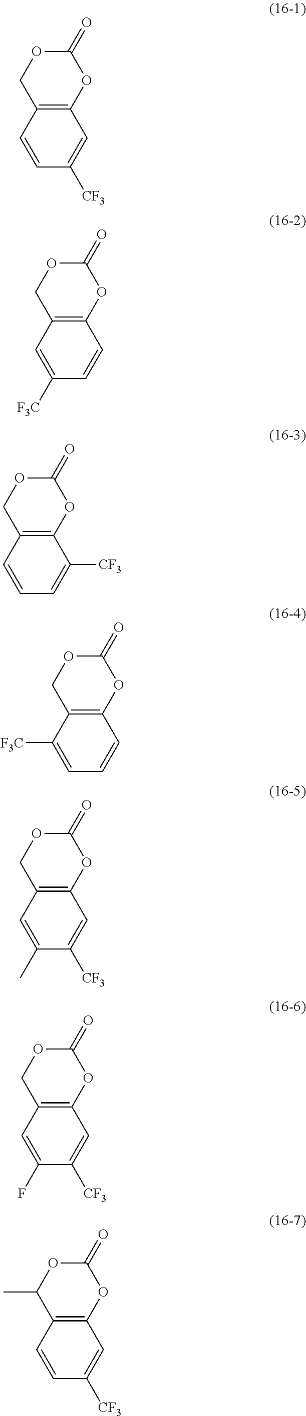

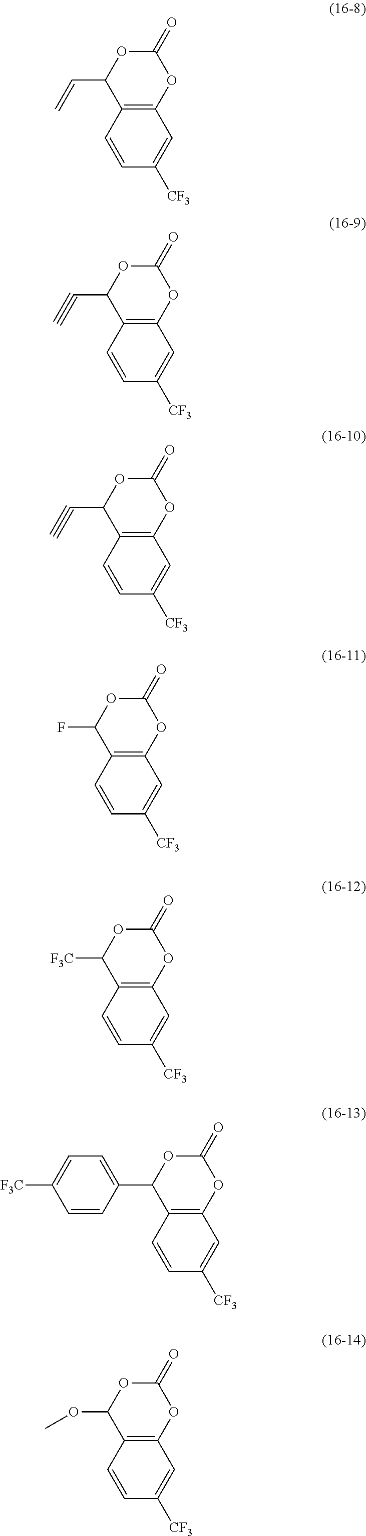

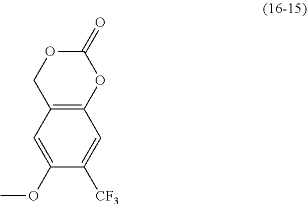 [SMILES: COc1cc2c(cc1C(F)(F)F)OC(=O)OC2]

The compound represented by Formula (17) is a 17th fluorine-containing compound having a cyclic structure. Details of each of R85 to R88 are similar to those of each of R47 to R51. Details of each of R89 to R92 are similar to those of each of R1 to R4. Note that one or more of R85 to R88 are each a trifluoromethyl group. Thus, the 17th fluorine-containing compound includes a benzene ring having a trifluoromethyl group introduced therein, and the number of the benzene rings each having the trifluoromethyl group introduced therein is one or more.

Specific examples of the 17th fluorine-containing compound include respective compounds represented by Formulae (17-1) to (17-14).

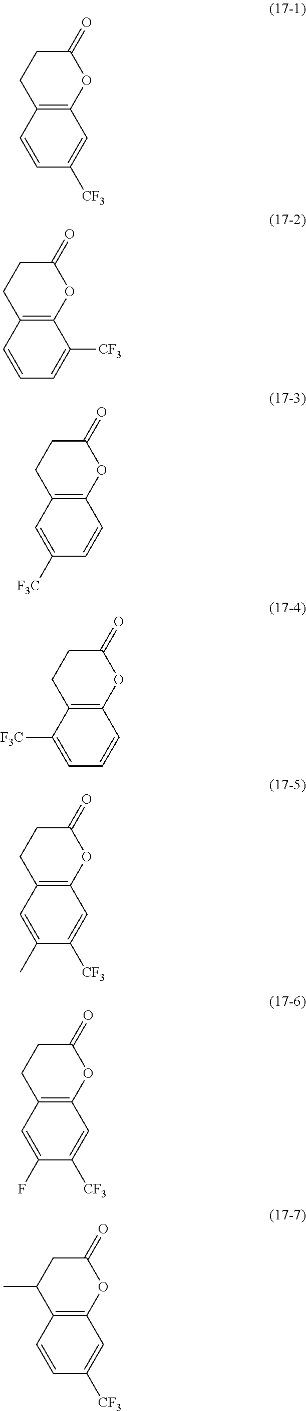

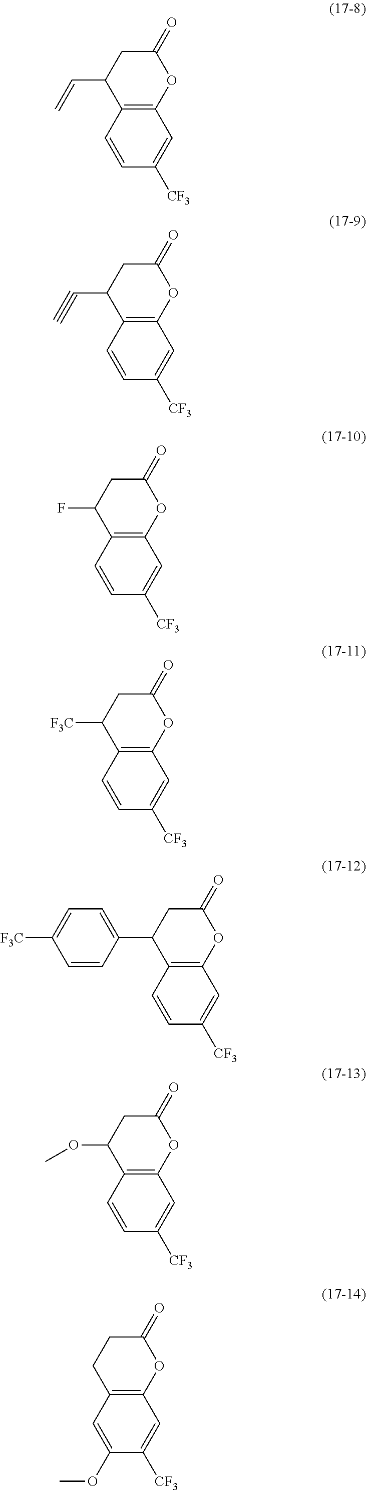

The compound represented by Formula (18) is an 18th fluorine-containing compound having a cyclic structure. Details of each of R93 to R96 are similar to those of each of R47 to R51. Details of each of R97 and R98 are similar to those of each of R1 to R4. Note that one or more of R93 to R96 are each a trifluoromethyl group. Thus, the 18th fluorine-containing compound includes a benzene ring having a trifluoromethyl group introduced therein, and the number of the benzene rings each having the trifluoromethyl group introduced therein is one or more.

Specific examples of the 18th fluorine-containing compound include respective compounds represented by Formulae (18-1) to (18-15).

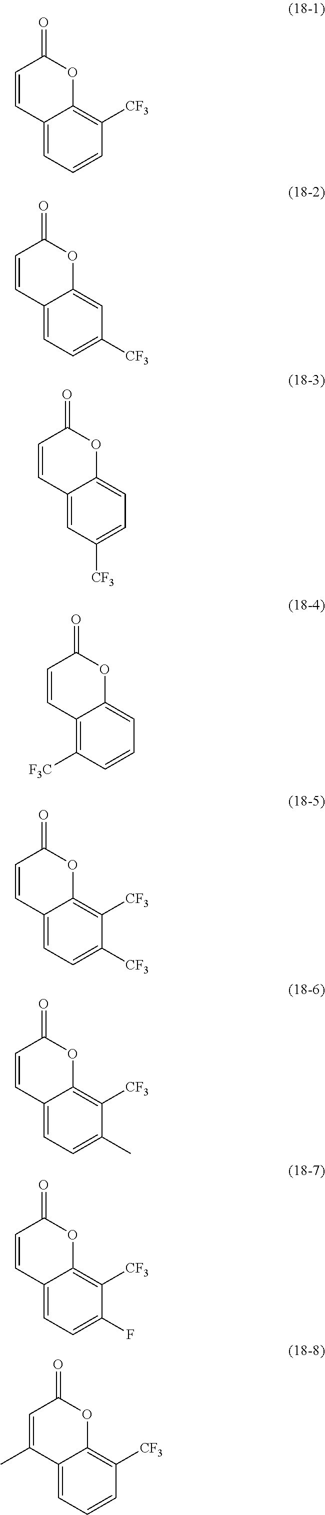

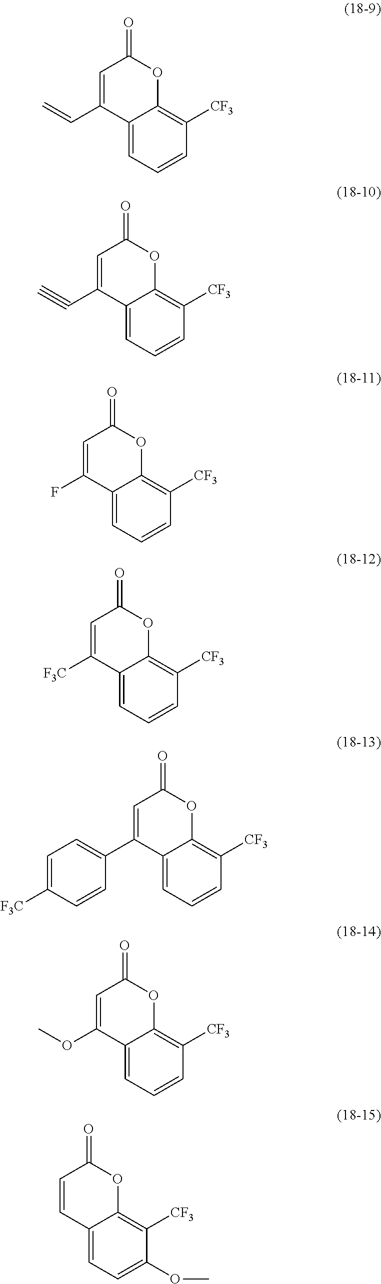

The compound represented by Formula (19) is a 19th fluorine-containing compound having a cyclic structure. Details of each of R99 to R102 are similar to those of each of R1 to R4. Note that one or more of R99 to R102 are each the fluorine-containing group. Thus, the 19th fluorine-containing compound includes a benzene ring having a trifluoromethyl group introduced therein, and the number of the benzene rings each having the trifluoromethyl group introduced therein is one or more.

Specific examples of the 19th fluorine-containing compound include respective compounds represented by Formulae (19-1) to (19-9).

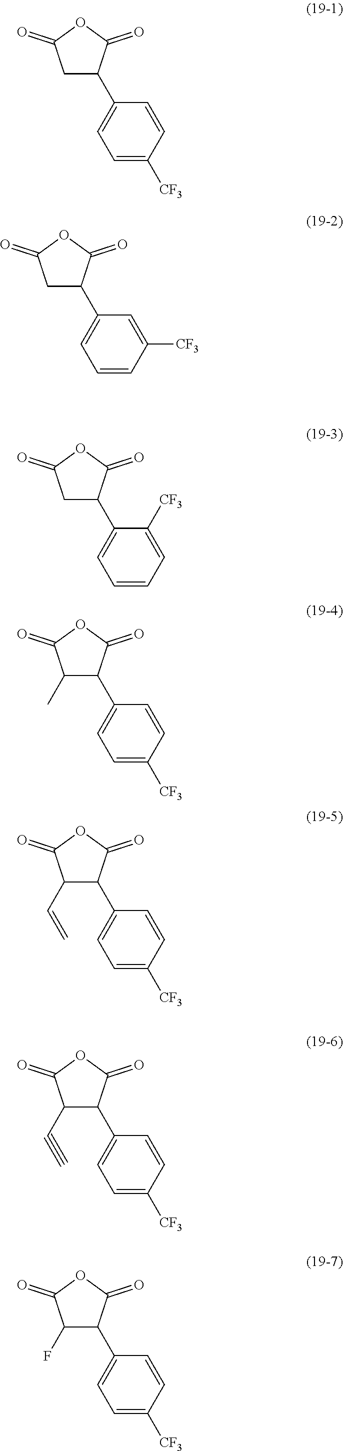

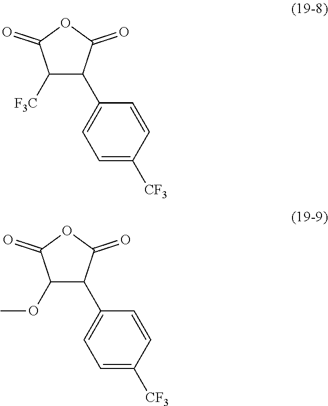 [SMILES: O=C1OC(=O)C(C(F)(F)F)C1c1ccc(C(F)(F)F)cc1 ; COC1C(=O)OC(=O)C1c1ccc(C(F)(F)F)cc1]

### (20th Fluorine-Containing Compound)

The compound represented by Formula (20) is a 20th fluorine-containing compound having a cyclic structure. Details of each of R103 to R108 are similar to those of each of R1 to R4. Note that one or more of R103 to R108 are each the fluorine-containing group. Thus, the 20th fluorine-containing compound includes a benzene ring having a trifluoromethyl group introduced therein, and the number of the benzene rings each having the trifluoromethyl group introduced therein is one or more.

Specific examples of the 20th fluorine-containing compound include respective compounds represented by Formulae (20-1) to (20-10).

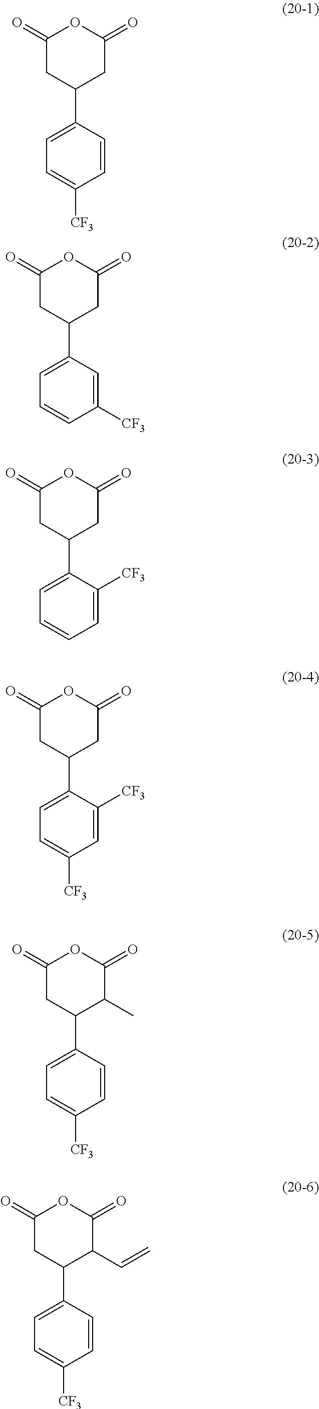

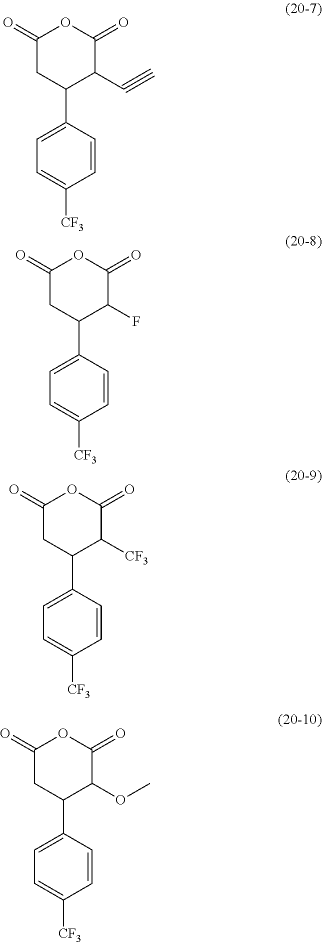

The compound represented by Formula (21) is a 21st fluorine-containing compound having a cyclic structure. Details of each of R109 to R112 are similar to those of each of R47 to R51. Note that one or more of R109 to R112 are each a trifluoromethyl group. Thus, the 21st fluorine-containing compound includes a benzene ring having a trifluoromethyl group introduced therein, and the number of the benzene rings each having the trifluoromethyl group introduced therein is one or more.

Specific examples of the 21st fluorine-containing compound include respective compounds represented by Formulae (21-1) to (21-5).

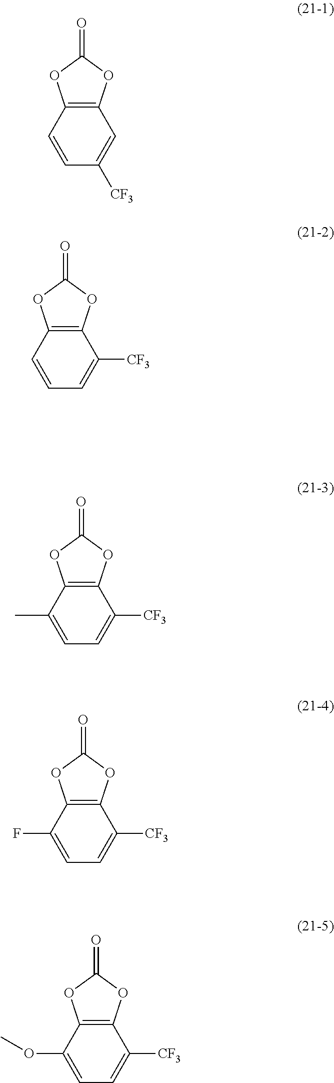 [SMILES: O=c1oc2ccc(C(F)(F)F)cc2o1 ; O=c1oc2cccc(C(F)(F)F)c2o1 ; Cc1ccc(C(F)(F)F)c2oc(=O)oc12 ; O=c1oc2c(F)ccc(C(F)(F)F)c2o1 ; COc1ccc(C(F)(F)F)c2oc(=O)oc12]

The compound represented by Formula (22) is a 22nd fluorine-containing compound having a cyclic structure. Details of each of R113 to R116 are similar to those of each of R47 to R51. Details of each of R117 and R118 are similar to those of each of R1 to R4. Note that one or more of R113 to R116 are each a trifluoromethyl group. Thus, the 22nd fluorine-containing compound includes a benzene ring having a trifluoromethyl group introduced therein, and the number of the benzene rings each having the trifluoromethyl group introduced therein is one or more.

Specific examples of the 22nd fluorine-containing compound include respective compounds represented by Formulae (22-1) to (22-14).

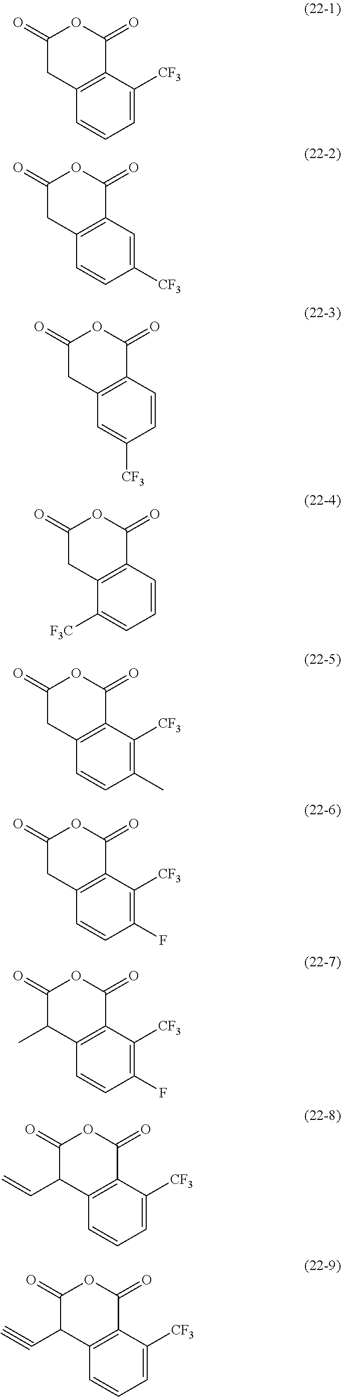

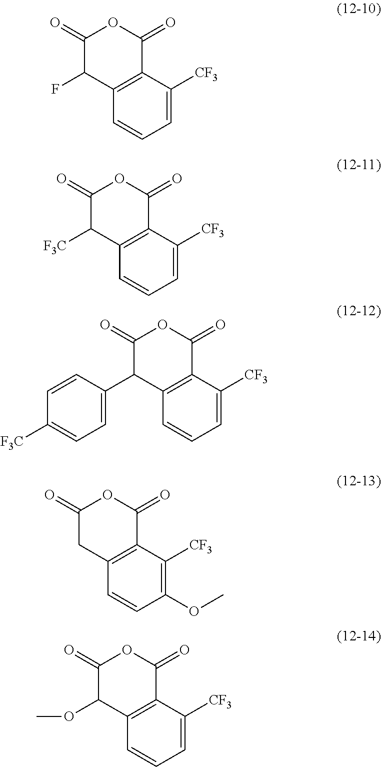

A content of the fluorine-containing compound in the electrolytic solution is not particularly limited, and in particular, is preferably within a range from 0.5 wt % to 2.0 wt % both inclusive. A reason for this is that a sufficiently favorable film derived from the fluorine-containing compound is formed on the surface of the electrode, which sufficiently suppresses the decomposition reaction of the electrolytic solution.

The content of the fluorine-containing compound described here is the sum total of the respective contents of the 22 compounds described above.

Note that the electrolytic solution may further include a solvent. The solvent includes any one or more of non-aqueous solvents (organic solvents), and the electrolytic solution including the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example.

The carbonic-acid-ester-based compound is, for example, a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is a chain carboxylic acid ester, for example. Specific examples of the chain carboxylic acid ester include methyl acetate, ethyl acetate, methyl propionate, ethyl propionate, propyl propionate, ethyl trimethylacetate, methyl butyrate, and ethyl butyrate.

The lactone-based compound is a lactone, for example. Specific examples of the lactone include γ-butyrolactone and γ-valerolactone.

Note that the ether may be the lactone-based compound described above, 1,2-dimethoxyethane, tetrahydrofuran, 1,3-dioxolane, or 1,4-dioxane, for example.

Note that the electrolytic solution may further include an electrolyte salt. The electrolyte salt is a light metal salt such as a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂).

A content of the electrolyte salt is not particularly limited and is specifically within a range from 0.3 mol/kg to 3.0 mol/kg both inclusive with respect to the solvent. A reason for this is that high ion conductivity is obtainable.

Note that the electrolytic solution may further include any one or more of additives.

Specifically, the additive includes any one or more of an unsaturated cyclic carbonic acid ester, a fluorinated cyclic carbonic acid ester, or a cyanated cyclic carbonic acid ester. A reason for this is that electrochemical stability of the electrolytic solution improves. This further suppresses the decomposition reaction of the electrolytic solution upon charging and discharging of the secondary battery, which further reduces a decrease in the discharge capacity even upon repeated charging and discharging.

The unsaturated cyclic carbonic acid ester is a cyclic carbonic acid ester having an unsaturated carbon bond (a carbon-carbon double bond). The number of unsaturated carbon bonds is not particularly limited and may be only one, or two or more.

The unsaturated cyclic carbonic acid ester includes any one or more of a vinylene-carbonate-based compound, a vinyl-ethylene-carbonate-based compound, or a methylene-ethylene-carbonate-based compound.

The vinylene-carbonate-based compound is an unsaturated cyclic carbonic acid ester having a configuration of a vinylene carbonate type. Specific examples of the vinylene-carbonate-based compound include vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one.

The vinyl-ethylene-carbonate-based compound is an unsaturated cyclic carbonic acid ester having a configuration of a vinyl ethylene carbonate type. Specific examples of the vinyl-ethylene-carbonate-based compound include vinyl ethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one.

The methylene-ethylene-carbonate-based compound is an unsaturated cyclic carbonic acid ester having a configuration of a methylene ethylene carbonate type. Specific examples of the methylene-ethylene-carbonate-based compound include methylene ethylene carbonate (4-methylene-1,3-dioxolane-2-one), 4,4-dimethyl-5-methylene-1,3-dioxolane-2-one, and 4,4-diethyl-5-methylene-1,3-dioxolane-2-one. Here, a compound having only one methylene group is given as an example of the methylene-ethylene-carbonate-based compound, but the methylene-ethylene-carbonate-based compound may include two or more methylene groups.

Note that the cyclic carbonic acid ester having an unsaturated carbon bond belongs to neither the fluorinated cyclic carbonic acid ester nor the cyanated cyclic carbonic acid ester, but belongs to the unsaturated cyclic carbonic acid ester.

The fluorinated cyclic carbonic acid ester is a cyclic carbonic acid ester including fluorine as a constituent element. The number of fluorines is not particularly limited and may be only one, or two or more. That is, the fluorinated cyclic carbonic acid ester is a compound resulting from substituting one or more hydrogens of a cyclic carbonic acid ester with one or more fluorines.

Specific examples of the fluorinated cyclic carbonic acid ester include fluoroethylene carbonate (4-fluoro-1,3-dioxolane-2-one) and difluoroethylene carbonate (4,5-difluoro-1,3-dioxolane-2-one).

Note that the cyclic carbonic acid ester including fluorine as a constituent element belongs to neither the unsaturated cyclic carbonic acid ester nor the cyanated cyclic carbonic acid ester, but belongs to the fluorinated cyclic carbonic acid ester.

The cyanated cyclic carbonic acid ester is a cyclic carbonic acid ester having a cyano group. The number of cyano groups is not particularly limited and may be only one, or two or more. That is, the cyanated cyclic carbonic acid ester is a compound resulting from substituting one or more hydrogens of a cyclic carbonic acid ester with one or more cyano groups.

Specific examples of the cyanated cyclic carbonic acid ester include cyanoethylene carbonate (4-cyano-1,3-dioxolane-2-one) and dicyanoethylene carbonate (4,5-dicyano-1,3-dioxolane-2-one).

Note that the cyclic carbonic acid ester having a cyano group belongs to neither the unsaturated cyclic carbonic acid ester nor the fluorinated cyclic carbonic acid ester, but belongs to the cyanated cyclic carbonic acid ester.

Further, the additive includes any one or more of a sulfonic acid ester, a sulfuric acid ester, a sulfurous acid ester, a dicarboxylic acid anhydride, a disulfonic acid anhydride, or a sulfonic acid carboxylic acid anhydride. A reason for this is that the electrochemical stability of the electrolytic solution improves. This further suppresses the decomposition reaction of the electrolytic solution upon charging and discharging of the secondary battery, which further reduces a decrease in the discharge capacity even upon repeated charging and discharging.

Specific examples of the sulfonic acid ester include 1,3-propane sultone, 1-propene-1,3-sultone, 1,4-butane sultone, 2,4-butane sultone, and methanesulfonic acid propargyl ester.

Specific examples of the sulfuric acid ester include 1,3,2-dioxathiolane 2,2-dioxide, 1,3,2-dioxathiane 2,2-dioxide, and 4-methylsulfonyloxymethyl-2,2-dioxo-1,3,2-dioxathiolane.

Specific examples of the sulfurous acid ester include 1,3-propane sultone, 1-propene-1,3-sultone, 1,4-butane sultone, 2,4-butane sultone, and methanesulfonic acid propargyl ester. Specific examples of the sulfurous acid ester include 1,3,2-dioxathiolane 2-oxide and 4-methyl-1,3,2-dioxathiolane 2-oxide.

Specific examples of the dicarboxylic acid anhydride include 1,4-dioxane-2,6-dione, succinic anhydride, and glutaric anhydride.

Specific examples of the disulfonic acid anhydride include 1,2-ethanedisulfonic anhydride, 1,3-propanedisulfonic anhydride, and hexafluoro 1,3-propanedisulfonic anhydride.

Specific examples of the sulfonic acid carboxylic acid anhydride include 2-sulfobenzoic anhydride and 2,2-dioxooxathiolane-5-one.

Further, the additive is a nitrile compound. A reason for this is that the electrochemical stability of the electrolytic solution improves. This further suppresses the decomposition reaction of the electrolytic solution upon charging and discharging of the secondary battery, which further reduces a decrease in the discharge capacity even upon repeated charging and discharging, and also suppresses generation of gas due to the decomposition reaction of the electrolytic solution.

The nitrile compound is a compound having one or more cyano groups (—CN). Specific examples of the nitrile compound include octanenitrile, benzonitrile, phthalonitrile, succinonitrile, glutaronitrile, adiponitrile, cebaconitrile, 1,3,6-hexanetricarbonitrile, 3,3′-oxydipropionitrile, 3-butoxypropionitrile, ethylene glycol bispropionitrile ether, 1,2,2,3-tetracyanopropane, tetracyanopropane, fumaronitrile, 7,7,8,8-tetracyanoquinodimethane, cyclopentanecarbonitrile, 1,3,5-cyclohexanetricarbonitrile, and 1,3-bis(dicyanomethylidene)indane.

Note that the cyanated cyclic carbonic acid ester described above is excluded from the nitrile compound described here.

In a case of manufacturing the electrolytic solution, the electrolyte salt is added to the solvent, following which the fluorine-containing compound is added to the solvent. The electrolyte salt and the fluorine-containing compound are thereby each dispersed or dissolved in the solvent. As a result, the electrolytic solution is prepared.

The electrolytic solution includes the fluorine-containing compound. More specifically, the electrolytic solution includes any one or more of the 22 fluorine-containing compounds (the first to 22nd fluorine-containing compounds) described above.

In this case, a favorable film derived from the fluorine-containing compound is formed on the surface of the electrode as described above, unlike when the electrolytic solution does not include the fluorine-containing compound and when the electrolytic solution includes another compound. This suppresses the decomposition reaction of the electrolytic solution upon charging and discharging of the secondary battery including the electrolytic solution, which reduces a decrease in the discharge capacity even upon repeated charging and discharging. Accordingly, it is possible for the secondary battery including the electrolytic solution to achieve a superior cyclability characteristic.

Note that the “other compound” described above is a compound that does not have any of the structures of the first to 22nd fluorine-containing compounds, but has a structure similar to the structures. Specific examples of the “other compound” include respective compounds represented by Formulae (41-1) and (41-2).

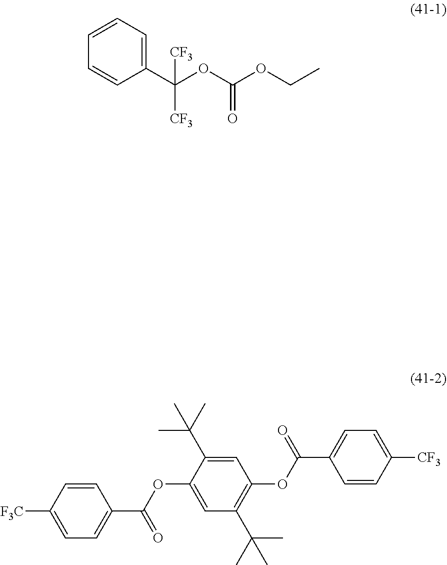 [SMILES: CCOC(=O)OC(c1ccccc1)(C(F)(F)F)C(F)(F)F ; CC(C)(C)c1cc(OC(=O)c2ccc(C(F)(F)F)cc2)c(C(C)(C)C)cc1OC(=O)c1ccc(C(F)(F)F)cc1]

In particular, the carbon number of each of the hydrocarbon group (the alkyl group, the alkenyl group, and the alkynyl group) and the oxygen-containing hydrocarbon group (the alkoxy group) in, without limitation, Formula (1) may be less than or equal to 3. This secures the solubility and the compatibility of the fluorine-containing compound. Accordingly, it is possible to achieve higher effects.

The carbon number of the alkyl group in, without limitation, Formula (1) may be less than or equal to 3. This secures the solubility and the compatibility of the fluorine-containing compound. Accordingly, it is possible to achieve higher effects.

The content of the fluorine-containing compound in the electrolytic solution may be within the range from 0.5 wt % to 2.0 wt % both inclusive. This sufficiently suppresses the decomposition reaction of the electrolytic solution. Accordingly, it is possible to achieve higher effects.

The electrolytic solution may include any one or more of the unsaturated cyclic carbonic acid ester, the fluorinated cyclic carbonic acid ester, or the cyanated cyclic carbonic acid ester. This further suppresses the decomposition reaction of the electrolytic solution. Accordingly, it is possible to achieve higher effects.

The electrolytic solution may include any one or more of the sulfonic acid ester, the sulfuric acid ester, the sulfurous acid ester, the dicarboxylic acid anhydride, the disulfonic acid anhydride, or the sulfonic acid carboxylic acid anhydride. This further suppresses the decomposition reaction of the electrolytic solution. Accordingly, it is possible to achieve higher effects.

The electrolytic solution may include the nitrile compound. This further suppresses the decomposition reaction of the electrolytic solution, and also suppresses generation of gas due to the decomposition reaction of the electrolytic solution. Accordingly, it is possible to achieve higher effects.

A description is given next of a secondary battery including the electrolytic solution described above according to an embodiment.

The secondary battery to be described here is a secondary battery that obtains a battery capacity using insertion and extraction of an electrode reactant, and includes a positive electrode, a negative electrode, and an electrolytic solution. The electrolytic solution is a liquid electrolyte.

In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is what is called a lithium-ion secondary battery. In the lithium-ion secondary battery, lithium is inserted and extracted in an ionic state.

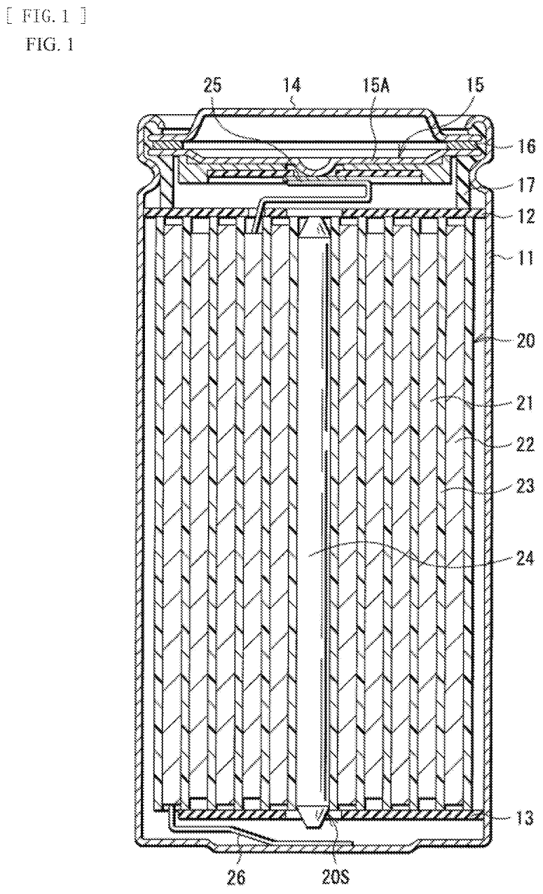

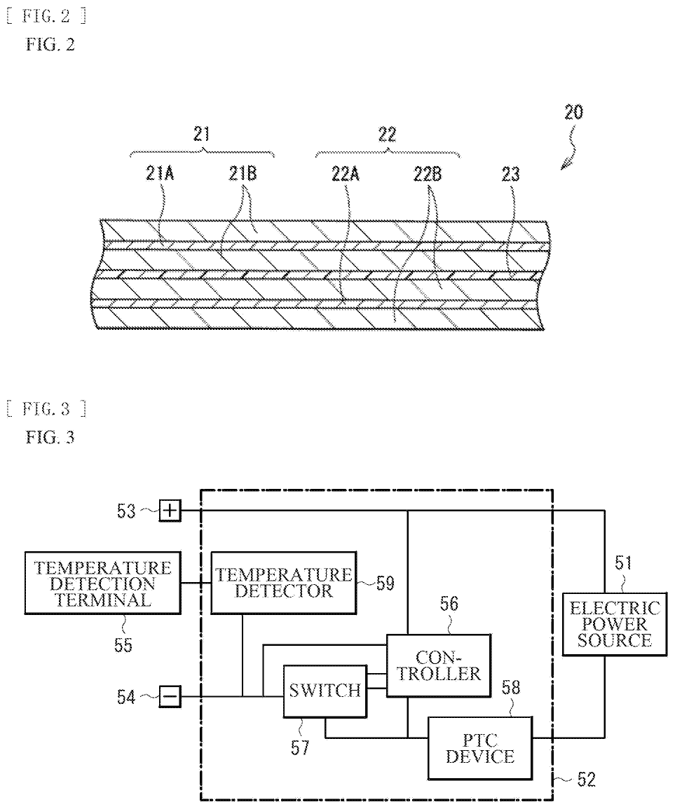

FIG. 1 illustrates a sectional configuration of the secondary battery. FIG. 2 illustrates a sectional configuration of a battery device 20 illustrated in FIG. 1. Note that FIG. 2 illustrates only a portion of the battery device 20.

As illustrated in FIGS. 1 and 2, the secondary battery mainly includes a battery can 11, a pair of insulating plates 12 and 13, the battery device 20, a positive electrode lead 25, and a negative electrode lead 26. The secondary battery to be described here is a secondary battery of a cylindrical type. The secondary battery of the cylindrical type includes the battery can 11 having a cylindrical shape that contains the battery device 20.

As illustrated in FIG. 1, the battery can 11 is a container member that contains, for example, the battery device 20. The battery can 11 has a hollow structure with a closed end part and an open end part, and includes any one or more of metal materials including, without limitation, iron, aluminum, an iron alloy, and an aluminum alloy. The battery can 11 has a surface that may be plated with a metal material such as nickel.

The insulating plates 12 and 13 are so disposed as to be opposed to each other with the battery device 20 interposed therebetween. Thus, the battery device 20 is sandwiched between the insulating plates 12 and 13.

A battery cover 14, a safety valve mechanism 15, and a thermosensitive resistive device (PTC device) 16 are crimped to the battery can 11 at the open end part by means of a gasket 17. The open end part of the battery can 11 is thereby sealed by the battery cover 14. Here, the battery cover 14 includes a material similar to the material included in the battery can 11. The safety valve mechanism 15 and the PTC device 16 are each disposed on an inner side of the battery cover 14. The safety valve mechanism 15 is electrically coupled to the battery cover 14 via the PTC device 16. The gasket 17 includes an insulating material and has a surface on which a material such as asphalt may be applied.

In the safety valve mechanism 15, a disk plate 15A inverts when an internal pressure of the battery can 11 reaches a certain level or higher due to an event such as an internal short-circuit or heating, thereby cutting off the electrical coupling between the battery cover 14 and the battery device 20. Electric resistance of the PTC device 16 increases in accordance with a rise in temperature, in order to prevent abnormal heat generation resulting from a large current.

As illustrated in FIGS. 1 and 2, the battery device 20 is a power generation device that includes a positive electrode 21, a negative electrode 22, a separator 23, and the electrolytic solution (not illustrated).

The battery device 20 is what is called a wound electrode body. That is, in the battery device 20, the positive electrode 21 and the negative electrode 22 are stacked on each other with the separator 23 interposed therebetween, and the stack of the positive electrode 21, the negative electrode 22, and the separator 23 is wound. Thus, the positive electrode 21 and the negative electrode 22 are opposed to each other with the separator 23 interposed therebetween, and are wound. A center pin 24 is disposed in a winding center space 20S of the battery device 20. The winding center space 20S is disposed in a winding center of the battery device 20. Note, however, that the center pin 24 may be omitted.

The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the metal material include aluminum.

Here, the positive electrode active material layer 21B is provided on each of the two opposed surfaces of the positive electrode current collector 21A. The positive electrode active material layer 21B includes any one or more of positive electrode active materials into which lithium is insertable and from which lithium is extractable. Note that the positive electrode active material layer 21B may be provided only on one of the two opposed surfaces of the positive electrode current collector 21A on a side where the positive electrode 21 is opposed to the negative electrode 22. Further, the positive electrode active material layer 21B may further include any one or more of other materials including, without limitation, a positive electrode binder and a positive electrode conductor. A method of forming the positive electrode active material layer 21B is not particularly limited and specifically includes any one or more of methods including, without limitation, a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table of elements. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, and LiMn₂O₄. Specific examples of the phosphoric acid compound include LiFePO₄, LiMnPO₄, and LiFe_{0.5}Mn_{0.5}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material. Specific examples of the carbon material include graphite, carbon black, acetylene black, and Ketjen black. Note that the electrically conductive material may be a metal material or a polymer compound, for example.

As illustrated in FIG. 2, the negative electrode 22 includes a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the metal material include copper.

Here, the negative electrode active material layer 22B is provided on each of the two opposed surfaces of the negative electrode current collector 22A. The negative electrode active material layer 22B includes any one or more of negative electrode active materials into which lithium is insertable and from which lithium is extractable. Note that the negative electrode active material layer 22B may be provided only on one of the two opposed surfaces of the negative electrode current collector 22A on a side where the negative electrode 22 is opposed to the positive electrode 21. Further, the negative electrode active material layer 22B may further include any one or more of other materials including, without limitation, a negative electrode binder and a negative electrode conductor. A method of forming the negative electrode active material layer 22B is not particularly limited and specifically includes any one or more of methods including, without limitation, a coating method, a vapor-phase method, a liquid-phase method, a thermal spraying method, and a firing (sintering) method.

The negative electrode active material is not particularly limited in kind, and specific examples thereof include a carbon material, a metal-based material, or both. A reason for this is that a high energy density is obtainable. Specific examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Specific examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

As illustrated in FIG. 2, the separator 23 is an insulating porous film interposed between the positive electrode 21 and the negative electrode 22, and allows lithium ions to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution, and the electrolytic solution has the configuration described above. That is, the electrolytic solution includes the fluorine-containing compound.

As illustrated in FIGS. 1 and 2, the positive electrode lead 25 is coupled to the positive electrode current collector 21A of the positive electrode 21. The positive electrode lead 25 includes any one or more of electrically conductive materials including, without limitation, aluminum. The positive electrode lead 25 is electrically coupled to the battery cover 14 via the safety valve mechanism 15.

As illustrated in FIGS. 1 and 2, the negative electrode lead 26 is coupled to the negative electrode current collector 22A of the negative electrode 22. The negative electrode lead 26 includes any one or more of electrically conductive materials including, without limitation, nickel. The negative electrode lead 26 is electrically coupled to the battery can 11.

The secondary battery operates as follows.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon charging and discharging, lithium is inserted and extracted in an ionic state.

In a case of manufacturing the secondary battery, the positive electrode 21 and the negative electrode 22 are fabricated, and the secondary battery is fabricated using the positive electrode 21, the negative electrode 22, and the electrolytic solution, following which a stabilization process is performed on the secondary battery, in accordance with a procedure described below. Note that the procedure for preparing the electrolytic solution is as described above.

First, a mixture (a positive electrode mixture) in which the positive electrode active material, the positive electrode binder, and the positive electrode conductor are mixed with each other is put into a solvent to thereby prepare a positive electrode mixture slurry in paste form. A composition of the positive electrode mixture may be changed as desired. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. Thus, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material, the negative electrode binder, and the negative electrode conductor are mixed with each other is put into a solvent to thereby prepare a negative electrode mixture slurry in paste form. A composition of the negative electrode mixture may be changed as desired. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. In this manner, the negative electrode active material layers 22B are formed on the respective two opposed surfaces of the negative electrode current collector 22A. Thus, the negative electrode 22 is fabricated.

First, the positive electrode lead 25 is coupled to the positive electrode current collector 21A of the positive electrode 21 by a method such as a welding method, and the negative electrode lead 26 is coupled to the negative electrode current collector 22A of the negative electrode 22 by a method such as a welding method. Thereafter, the positive electrode 21 and the negative electrode 22 are stacked on each other with the separator 23 interposed therebetween, following which the stack of the positive electrode 21, the negative electrode 22, and the separator 23 is wound to thereby form a wound body (not illustrated) having the winding center space 20S. The wound body has a configuration similar to that of the battery device 20 except that the positive electrode 21, the negative electrode 22, and the separator 23 are each not impregnated with the electrolytic solution. Thereafter, the center pin 24 is disposed in the winding center space 20S of the wound body.

Thereafter, with the wound body interposed between the insulating plates 12 and 13, the wound body is placed inside the battery can 11 having the open end part together with the insulating plates 12 and 13. In this case, the positive electrode lead 25 is coupled to the safety valve mechanism 15 by a method such as a welding method, and the negative electrode lead 26 is coupled to the battery can 11 by a method such as a welding method. Thereafter, the electrolytic solution is injected into the battery can 11 to thereby impregnate the wound body with the electrolytic solution. The positive electrode 21, the negative electrode 22, and the separator 23 are thereby each impregnated with the electrolytic solution. The battery device 20 is thus fabricated.

Lastly, the battery cover 14, the safety valve mechanism 15, and the PTC device 16 are placed inside the battery can 11 having the open end part. Thereafter, the open end part of the battery can 11 is crimped by means of the gasket 17. In this manner, the battery cover 14, the safety valve mechanism 15, and the PTC device 16 are secured to the open end part of the battery can 11, and the battery device 20 is sealed in the battery can 11. As a result, the secondary battery is assembled.

The secondary battery after being assembled is charged and discharged. Various conditions including, for example, an environment temperature, the number of times of charging and discharging (the number of cycles), and charging and discharging conditions may be set as desired. In this manner, a film is formed on the surface of each of the positive electrode 21 and the negative electrode 22, and the state of the secondary battery is electrochemically stabilized. In this case, a favorable film derived from the fluorine-containing compound is formed, as described above. As a result, the secondary battery is completed.

The secondary battery includes the electrolytic solution having the configuration described above. In this case, the decomposition reaction of the electrolytic solution is suppressed upon charging and discharging for the reason described above, which reduces a decrease in the discharge capacity even upon repeated charging and discharging. Accordingly, it is possible to achieve a superior cyclability characteristic.

In particular, the secondary battery may include a lithium-ion secondary battery. This makes it possible to obtain a sufficient battery capacity stably through the use of insertion and extraction of lithium. Accordingly, it is possible to achieve higher effects.

Other action and effects of the secondary battery are similar to those of the electrolytic solution described above according to an embodiment.

The configuration of the secondary battery described above is appropriately modifiable, including as described below, according to an embodiment. Note that any two or more of the following series of modifications may be combined with each other.

The description has been given of the case where the secondary battery has a battery structure of the cylindrical type. However, although not specifically illustrated here, the battery structure is not particularly limited in kind and may thus be, for example, a laminated-film type, a prismatic type, a coin type, or a button type.

The separator 23, which is a porous film, is used. However, although not specifically illustrated here, a separator of a stacked type including a polymer compound layer may be used.

For example, the separator of the stacked type includes a porous film having two opposed surfaces and the polymer compound layer provided on one of or each of the two opposed surfaces of the porous film. A reason for this is that adherence of the separator to each of the positive electrode 21 and the negative electrode 22 improves, which suppresses misalignment (winding displacement) of the battery device 20. This suppresses swelling of the secondary battery even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include any one or more kinds of insulating particles. A reason for this is that the insulating particles promote heat dissipation upon heat generation by the secondary battery, thus improving safety or heat resistance of the secondary battery. The insulating particles include an inorganic material, a resin material, or both. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

When the separator of the stacked type is used also, lithium ions are movable between the positive electrode 21 and the negative electrode 22, and similar effects are therefore obtainable. In this case, particularly, the safety of the secondary battery is improved as described above. Accordingly, it is possible to achieve higher effects.

The electrolytic solution, which is a liquid electrolyte, is used. However, although not specifically illustrated here, an electrolyte layer that is a gel electrolyte may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

For example, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium ions are movable between the positive electrode 21 and the negative electrode 22 via the electrolyte layer, and similar effects are therefore obtainable. In this case, particularly, the leakage of the electrolytic solution is prevented as described above. Accordingly, it is possible to achieve higher effects.

Applications (application examples) of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery pack may include a single battery, or may include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration of the application example described below is merely an example, and is appropriately modifiable.

FIG. 3 illustrates a block configuration of a battery pack. The battery pack described here is a battery pack (what is called a soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51 and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside through the positive electrode terminal 53 and the negative electrode terminal 54 and is thus chargeable and dischargeable. The circuit board 52 includes a controller 56, a switch 57, a PTC device 58, and a temperature detector 59. However, the PTC device 58 may be omitted.

The controller 56 includes, for example, a central processing unit (CPU) and a memory and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55 and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1-1 to 1-27 and Comparative Examples 1 to 3

Secondary batteries were fabricated, following which the secondary batteries were each evaluated for its characteristic as described below.

### [Fabrication of Secondary Battery]

The lithium-ion secondary batteries of the cylindrical type illustrated in FIGS. 1 and 2 were fabricated in accordance with the following procedure.

### (Fabrication of Positive Electrode)

First, 91 parts by mass of the positive electrode active material (lithium cobalt oxide (LiCoO₂) that was the lithium-containing compound (an oxide)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone that was an organic solvent), following which the solvent was stirred to thereby prepare a positive electrode mixture slurry in paste form. Thereafter, the positive electrode mixture slurry was applied on the two opposed surfaces of the positive electrode current collector 21A (a band-shaped aluminum foil having a thickness of 12 μm) by means of a coating apparatus, following which the applied positive electrode mixture slurry was dried to thereby form the positive electrode active material layers 21B. Lastly, the positive electrode active material layers 21B were compression-molded by means of a roll pressing machine. The positive electrode 21 was thus fabricated.

### (Fabrication of Negative Electrode)

First, 93 parts by mass of the negative electrode active material and 7 parts by mass of the negative electrode binder (polyvinylidene difluoride) were mixed with each other to thereby obtain a negative electrode mixture. Used as the negative electrode active material was a mixture of 63 parts by mass of artificial graphite that was the carbon material and 30 parts by mass of silicon oxide (SiO) that was the metal-based material. Thereafter, the negative electrode mixture was put into a solvent (N-methyl-2-pyrrolidone that was an organic solvent), following which the solvent was stirred to thereby prepare a negative electrode mixture slurry in paste form. Thereafter, the negative electrode mixture slurry was applied on the two opposed surfaces of the negative electrode current collector 22A (a band-shaped copper foil having a thickness of 15 μm) by means of a coating apparatus, following which the applied negative electrode mixture slurry was dried to thereby form the negative electrode active material layers 22B. Lastly, the negative electrode active material layers 22B were compression-molded by means of a roll pressing machine. The negative electrode 22 was thus fabricated.

### (Preparation of Electrolytic Solution)

The electrolyte salt (LiPF₆ that was a lithium salt) was added to the solvent (ethylene carbonate that was the cyclic carbonic acid ester, and dimethyl carbonate that was the chain carbonic acid ester), following which the solvent was stirred. A mixture ratio (a weight ratio) between ethylene carbonate and dimethyl carbonate in the solvent was set to 20:80. The content of the electrolyte salt was set to 1.2 mol/kg with respect to the solvent. Thereafter, the fluorine-containing compound was added to the solvent to which the electrolyte salt was added, following which the solvent was stirred. A classification and the kind of the fluorine-containing compound were as listed in Tables 1 and 2. The “classification” indicates which of the first to 22nd fluorine-containing compounds the fluorine-containing compound was. In this manner, the electrolytic solution was prepared.

Note that, for comparison, the electrolytic solution was prepared by a similar procedure except that the fluorine-containing compound was not used. Further, the electrolytic solution was prepared by a similar procedure except that the other compound (the respective compounds represented by Formulae (41-1) and (41-2)) was used instead of the fluorine-containing compound.

### (Assembly of Secondary Battery)

First, the positive electrode lead 25 including aluminum was welded to the positive electrode current collector 21A of the positive electrode 21, and the negative electrode lead 26 including copper was welded to the negative electrode current collector 22A of the negative electrode 22.

Thereafter, the positive electrode 21 and the negative electrode 22 were stacked on each other with the separator 23 (a fine porous polyethylene film having a thickness of 15 μm) interposed therebetween, following which the stack of the positive electrode 21, the negative electrode 22, and the separator 23 was wound to thereby fabricate the wound body having the winding center space 20S. Thereafter, the center pin 24 was disposed in the winding center space 20S of the wound body.

Thereafter, the insulating plates 12 and 13 were placed inside the battery can 11 having the open end part together with the wound body. In this case, the positive electrode lead 25 was welded to the safety valve mechanism 15, and the negative electrode lead 26 was welded to the battery can 11. Thereafter, the electrolytic solution was injected into the battery can 11. In this manner, the wound body was impregnated with the electrolytic solution. As a result, the battery device 20 was fabricated.

Lastly, the battery cover 14, the safety valve mechanism 15, and the PTC device 16 were placed inside the battery can 11 having the open end part, following which the open end part of the battery can 11 was crimped by means of the gasket 17. Accordingly, the battery can 11 was sealed, and thus the secondary battery was assembled.

### (Stabilization of Secondary Battery)

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of 4.2 V until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours. As a result, the secondary battery was completed.

Note that, after the completion of the secondary battery, the content (wt %) of the fluorine-containing compound in the electrolytic solution was measured by inductively coupled plasma (ICP) optical emission spectroscopy. Results of the measurement were as listed in Tables 1 and 2.

### [Characteristic Evaluation of Secondary Battery]

Evaluation of the secondary batteries for their cyclability characteristics revealed the results presented in Tables 1 and 2.

In a case of examining the cyclability characteristic, first, the secondary battery was charged in a high-temperature environment (at a temperature of 50° C.), following which the charged secondary battery was left standing (for a standing time of 3 hours) in the same environment. Upon charging, the secondary battery was charged with a constant current of 1 C until a voltage reached 4.2 V, and was thereafter charged with a constant voltage of 4.2 V until a current reached 0.05 C. Note that 1 C was a value of a current that caused the battery capacity to be completely discharged in 1 hour.

Thereafter, the secondary battery was discharged in the same environment to thereby measure a discharge capacity (a first-cycle discharge capacity). Upon discharging, the secondary battery was discharged with a constant current of 3 C until a voltage reached 3.0 V. Note that 3 C was a value of a current that caused the battery capacity to be completely discharged in 10/3 hours.

Thereafter, the secondary battery was repeatedly charged and discharged in the same environment until the number of cycles reached 100 cycles to thereby measure the discharge capacity (a 100th-cycle discharge capacity). Charging and discharging conditions in and after a second cycle were similar to those in the first cycle.

Lastly, a capacity retention rate as an index for evaluating the cyclability characteristic was calculated based on the following calculation expression: capacity retention rate (%)=(100th-cycle discharge capacity/first-cycle discharge capacity)×100.

TABLE 1

| | | | | Capacity |
|---|---|---|---|---|
| | Fluorine-containing compound | | Content | retention |
| | Classification | Kind | (wt %) | rate (%) |
| Example 1-1 | First | Formula (1-2) | 0.2 | 61 |
| Example 1-2 | | | 0.5 | 67 |
| Example 1-3 | | | 1.0 | 68 |
| Example 1-4 | | | 1.5 | 69 |
| Example 1-5 | | | 2.0 | 66 |
| Example 1-6 | | | 3.0 | 60 |
| Example 1-7 | Second | Formula (2-3) | 1.5 | 65 |
| Example 1-8 | Third | Formula (3-1) | 1.5 | 67 |
| Example 1-9 | Fourth | Formula (4-1) | 1.5 | 66 |
| Example 1-10 | Fifth | Formula (5-1) | 1.5 | 65 |
| Example 1-11 | Sixth | Formula (6-7) | 1.5 | 67 |
| Example 1-12 | Seventh | Formula (7-2) | 1.5 | 67 |
| Example 1-13 | Eighth | Formula (8-2) | 1.5 | 66 |
| Example 1-14 | Ninth | Formula (9-1) | 1.5 | 66 |
| Example 1-15 | 10th | Formula (10-1) | 1.5 | 70 |
| Example 1-16 | 11th | Formula (11-2) | 1.5 | 69 |
| Example 1-17 | 12th | Formula (12-1) | 1.5 | 68 |
| Example 1-18 | 13th | Formula (13-1) | 1.5 | 70 |
| Example 1-19 | 14th | Formula (14-1) | 1.5 | 65 |
| Example 1-20 | 15th | Formula (15-1) | 1.5 | 68 |

TABLE 2

| | | | | Capacity |
|---|---|---|---|---|
| | Fluorine-containing compound | | Content | retention |
| | Classification | Kind | (wt %) | rate (%) |
| Example 1-21 | 16th | Formula (16-1) | 1.5 | 69 |
| Example 1-22 | 17th | Formula (17-2) | 1.5 | 65 |
| Example 1-23 | 18th | Formula (18-5) | 1.5 | 66 |
| Example 1-24 | 19th | Formula (19-1) | 1.5 | 69 |
| Example 1-25 | 20th | Formula (20-1) | 1.5 | 68 |
| Example 1-26 | 21st | Formula (21-2) | 1.5 | 69 |
| Example 1-27 | 22nd | Formula (22-1) | 1.5 | 67 |
| Comparative | — | — | — | 42 |
| example 1 | | | | |
| Comparative | — | Formula (41-1) | 1.5 | 43 |
| example 2 | | | | |
| Comparative | — | Formula (41-2) | 1.5 | 46 |
| example 3 | | | | |

As indicated in Tables 1 and 2, when the electrolytic solution included the other compound (Comparative examples 2 and 3), the capacity retention rate increased only slightly as compared with when the electrolytic solution did not include the other compound (Comparative example 1).

In contrast, when the electrolytic solution included the fluorine-containing compound (Examples 1-1 to 1-27), the capacity retention rate increased markedly as compared with when the electrolytic solution did not include the fluorine-containing compound (Comparative example 1).

In particular, when the electrolytic solution included the fluorine-containing compound and the content of the fluorine-containing compound in the electrolytic solution was within the range from 0.5 wt % to 2.0 wt % both inclusive, the capacity retention rate further increased.

### Examples 2-1 to 2-6

As indicated in Table 3, secondary batteries were fabricated by a similar procedure except that an additive was included in the electrolytic solution, following which the secondary batteries were each evaluated for its characteristic (the cyclability characteristic). The additive was the unsaturated cyclic carbonic acid ester, the fluorinated cyclic carbonic acid ester, or the cyanated cyclic carbonic acid ester. A classification, a kind, and a content (wt %) of the additive were as listed in Table 3.

Specifically, vinylene carbonate (VC) was used as the unsaturated cyclic carbonic acid ester. Fluoroethylene carbonate (FEC) was used as the fluorinated cyclic carbonic acid ester. Cyanoethylene carbonate (CEC) was used as the cyanated cyclic carbonic acid ester.

TABLE 3

| | Fluorine-containing | | | | | | Capacity |
|---|---|---|---|---|---|---|---|
| | compound | | | Additive | | | retention |
| | | | Content | | | Content | rate |
| | Classification | Kind | (wt %) | Classification | Kind | (wt %) | (%) |
| Example 1-4 | First | Formula | 1.5 | — | — | — | 69 |
| | | (1-2) | | | | | |
| Example 2-1 | | | | Unsaturated | VC | 1.0 | 75 |
| | | | | cyclic carbonic | | | |
| Example 2-2 | | | | acid ester | | 5.0 | 76 |
| Example 2-3 | | | | Fluorinated | FEC | 1.0 | 76 |
| | | | | cyclic carbonic | | | |
| Example 2-4 | | | | acid ester | | 5.0 | 78 |
| Example 2-5 | | | | Cyanated cyclic | CEC | 1.0 | 77 |
| | | | | carbonic acid | | | |
| Example 2-6 | | | | ester | | 5.0 | 78 |

As indicated in Table 3, when the electrolytic solution included the additive (the unsaturated cyclic carbonic acid ester, the fluorinated cyclic carbonic acid ester, or the cyanated cyclic carbonic acid ester) (Examples 2-1 to 2-6), the capacity retention rate further increased as compared with when the electrolytic solution included no additive (Example 1-4).

### Examples 3-1 to 3-18

As indicated in Table 4, secondary batteries were fabricated by a similar procedure except that an additive was included in the electrolytic solution, following which the secondary batteries were each evaluated for its characteristic (the cyclability characteristic). The additive was the sulfonic acid ester, the sulfuric acid ester, the sulfurous acid ester, the dicarboxylic acid anhydride, the disulfonic acid anhydride, or the sulfonic acid carboxylic acid anhydride. The classification, the kind, and the content (wt %) of the additive were as listed in Table 4.

Specifically, used as the sulfonic acid ester were 1,3-propane sultone (PS), 1-propene-1,3-sultone (PRS), 1,4-butane sultone (BS1), 2,4-butane sultone (BS2), and methanesulfonic acid propargyl ester (MSP).

Used as the sulfuric acid ester were 1,3,2-dioxathiolane 2,2-dioxide (OTO), 1,3,2-dioxathiane 2,2-dioxide (OTA), and 4-methylsulfonyloxymethyl-2,2-dioxo-1,3,2-dioxathiolane (SOTO).

Used as the sulfurous acid ester were 1,3,2-dioxathiolane 2-oxide (DTO) and 4-methyl-1,3,2-dioxathiolane 2-oxide (MDTO).

Used as the dicarboxylic acid anhydride were 1,4-dioxane-2,6-dione (DOD), succinic anhydride (SA), and glutaric anhydride (GA).

Used as the disulfonic acid anhydride were 1,2-ethanedisulfonic anhydride (ESA), 1,3-propanedidisulfonic anhydride (PSA), and hexafluoro 1,3-propanedisulfonic anhydride (FPSA).

Used as the sulfonic acid carboxylic acid anhydride were 2-sulfobenzoic anhydride (SBA) and 2,2-dioxooxathiolane-5-one (DOTO).

TABLE 4

| | Fluorine-containing | | | | | | Capacity |
|---|---|---|---|---|---|---|---|
| | compound | | | Additive | | | retention |
| | | | Content | | | Content | rate |
| | Classification | Kind | (wt %) | Classification | Kind | (wt %) | (%) |
| Example 1-4 | First | Formula | 1.5 | — | — | — | 69 |
| Example 3-1 | | (1-2) | | Sulfonic acid | PS | 1.0 | 76 |
| Example 3-2 | | | | ester | PRS | 1.0 | 74 |
| Example 3-3 | | | | | BS1 | 1.0 | 73 |
| Example 3-4 | | | | | BS2 | 1.0 | 73 |
| Example 3-5 | | | | | MSP | 1.0 | 77 |
| Example 3-6 | | | | Sulfuric acid | OTO | 1.0 | 75 |
| Example 3-7 | | | | ester | OTA | 1.0 | 74 |
| Example 3-8 | | | | | SOTO | 1.0 | 75 |
| Example 3-9 | | | | Sulfurous | DTO | 1.0 | 76 |
| Example 3-10 | | | | acid ester | MDTO | 1.0 | 75 |
| Example 3-11 | | | | Dicarboxylic | DOD | 1.0 | 73 |
| Example 3-12 | | | | acid | SA | 1.0 | 73 |
| Example 3-13 | | | | anhydride | GA | 1.0 | 74 |
| Example 3-14 | | | | Disulfonic | ESA | 1.0 | 78 |
| Example 3-15 | | | | acid | PSA | 1.0 | 79 |
| Example 3-16 | | | | anhydride | FPSA | 1.0 | 75 |
| Example 3-17 | | | | Sulfonic acid | SBA | 1.0 | 75 |
| Example 3-18 | | | | carboxylic | DOTO | 1.0 | 76 |
| | | | | acid | | | |
| | | | | anhydride | | | |

As indicated in Table 4, the capacity retention rate further increased when the electrolytic solution included the additive (the sulfonic acid ester, the sulfuric acid ester, the sulfurous acid ester, the dicarboxylic acid anhydride, the disulfonic acid anhydride, or the sulfonic acid carboxylic acid anhydride) (Examples 3-1 to 3-18), as compared with when the electrolytic solution included no additive (Example 1-4).

### Examples 4-1 to 4-18

As indicated in Table 5, secondary batteries were fabricated by a similar procedure except that an additive (the nitrile compound) was included in the electrolytic solution, following which the secondary batteries were each evaluated for its characteristic (the cyclability characteristic and safety). The classification, the kind, and the content (wt %) of the additive were as listed in Table 5.

Specifically, used as the nitrile compound were octanenitrile (ON), benzonitrile (BN), phthalonitrile (PN), succinonitrile (SN), glutaronitrile (GN), adiponitrile (AN), cebaconitrile (SBN), 1,3,6-hexanetricarbonitrile (HCN), 3,3′-oxydipropionitrile (OPN), 3-butoxypropionitrile (BPN), ethylene glycol bispropionitrile ether (EGPN), 1,2,2,3-tetracyanopropane (TCP), tetracyanoethylene (TCE), fumaronitrile (FN), 7,7,8,8-tetracyanoquinodimethane (TCQ), cyclopentanecarbonitrile (CPCN), 1,3,5-cyclohexanetricarbonitrile (CHCN), and 1,3-bis(dicyanomethylidene)indane (BCMI).

Here, as described above, the safety was evaluated as the characteristic of the secondary battery in addition to the cyclability characteristic. In a case of examining the safety, the secondary battery was stored in a high-temperature environment (at a temperature of 80° C.), followed by measuring a time (operation time) taken for the safety valve mechanism 15 to operate due to an increase in an internal pressure of the battery can 11. The operation time was an index for evaluating the safety (gas generation characteristic), or a parameter representing what is called a gas generation suppression degree. That is, the longer the operation time, the longer the time taken for the safety valve mechanism 15 to operate. The longer operation time meant that the generation of gas due to the decomposition reaction of the electrolytic solution inside the battery can 11 was suppressed more.

Note that the values of the operation time listed in Table 5 are values normalized with respect to the operation time measured in Example 1-4 assumed to be 1.0.

Here, an increase in the internal pressure of the battery can 11 indicated that the decomposition reaction of the electrolytic solution occurred inside the battery can 11, and thus gas was generated due to the decomposition reaction of the electrolytic solution. Further, the operation of the safety valve mechanism 15 indicated that electrical coupling between the battery cover 14 and the battery device 20 was cut off.

TABLE 5

| | Fluorine-containing | | | | | | Capacity | |
|---|---|---|---|---|---|---|---|---|
| | compound | | | Additive | | | retention | Operation |
| | | | Content | | | Content | rate | time |
| | Classification | Kind | (wt %) | Classification | Kind | (wt %) | (%) | (normalized) |
| Example 1-4 | First | Formula | 1.5 | — | — | — | 69 | 1.0 |
| Example 4-1 | | (1-2) | | Nitrile | ON | 0.5 | 70 | 1.2 |
| Example 4-2 | | | | compound | BN | 0.5 | 69 | 1.1 |
| Example 4-3 | | | | | PN | 0.5 | 68 | 1.1 |
| Example 4-4 | | | | | SN | 0.5 | 69 | 1.5 |
| Example 4-5 | | | | | GN | 0.5 | 68 | 1.4 |
| Example 4-6 | | | | | AN | 0.5 | 67 | 1.5 |
| Example 4-7 | | | | | SBN | 0.5 | 70 | 1.3 |
| Example 4-8 | | | | | HCN | 0.5 | 70 | 1.5 |
| Example 4-9 | | | | | OPN | 0.5 | 68 | 1.2 |
| Example 4-10 | | | | | BPN | 0.5 | 67 | 1.1 |
| Example 4-11 | | | | | EGPN | 0.5 | 69 | 1.5 |
| Example 4-12 | | | | | TCP | 0.5 | 68 | 1.5 |
| Example 4-13 | | | | | TCE | 0.5 | 67 | 1.1 |
| Example 4-14 | | | | | FN | 0.5 | 67 | 1.5 |
| Example 4-15 | | | | | TCQ | 0.5 | 68 | 1.1 |
| Example 4-16 | | | | | CPCN | 0.5 | 70 | 1.2 |
| Example 4-17 | | | | | CHCN | 0.5 | 69 | 1.1 |
| Example 4-18 | | | | | BCMI | 0.5 | 67 | 1.1 |

As indicated in Table 5, when the electrolytic solution included the additive (the nitrile compound) (Examples 4-1 to 4-18), the operation time increased while a substantially similarly high capacity retention rate was maintained, as compared with when the electrolytic solution included no additive (Example 1-4).

Based upon the results presented in Tables 1 to 5, when the electrolytic solution included the fluorine-containing compound, a high capacity retention rate was obtained. The secondary battery including the electrolytic solution therefore achieved a superior cyclability characteristic.

The configuration of the present technology is not limited to those described herein, and is therefore modifiable in a variety of suitable ways.

For example, the description has been given of the case where the battery device has a device structure of a wound type. However, the device structure of the battery device is not particularly limited. Therefore, the device structure may be any other device structure, for example, of a stacked type or a zigzag folded type. In the stacked type, the positive electrode and the negative electrode are alternately stacked on each other with the separator interposed therebetween. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited thereto. Accordingly, the present technology may achieve any other suitable effect.

1. A secondary battery comprising:
a positive electrode;
a negative electrode; and
an electrolytic solution including a fluorine-containing compound, wherein the fluorine-containing compound includes at least one of respective compounds represented by Formulae (1) to (22), 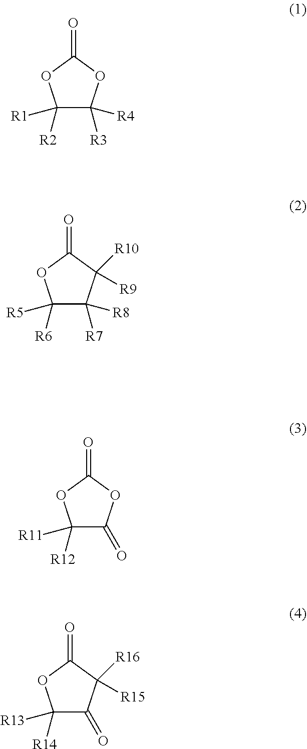
where
each of R1 to R16 is any of hydrogen (H), fluorine (F), a hydrocarbon group, an oxygen-containing hydrocarbon group, a fluorinated hydrocarbon group, or a fluorine-containing group represented by Formula (30),
at least one of R1 to R4 is the fluorine-containing group represented by Formula (30),
at least one of R5 to R10 is the fluorine-containing group represented by Formula (30),
at least one of R11 or R12 is the fluorine-containing group, and
at least one of R13 to R16 is the fluorine-containing group, 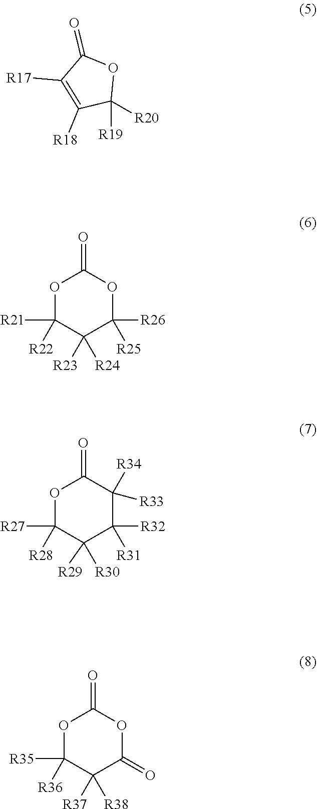
where
each of R17 to R38 is any of hydrogen, fluorine, a hydrocarbon group, an oxygen-containing hydrocarbon group, a fluorinated hydrocarbon group, or the fluorine-containing group represented by Formula (30),
at least one of R17 to R20 is the fluorine-containing group,
at least one of R21 to R26 is the fluorine-containing group,
at least one of R27 to R34 is the fluorine-containing group, and
at least one of R35 to R38 is the fluorine-containing group, 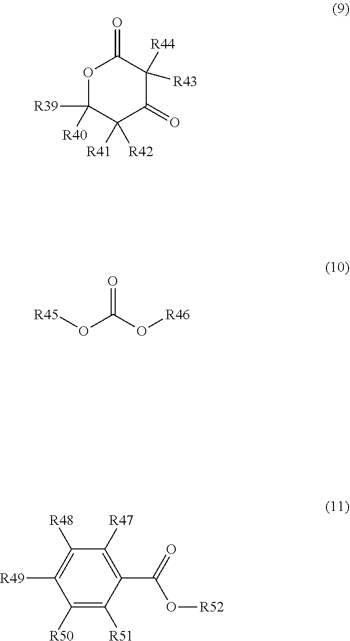
where
each of R39 to R44 is any of hydrogen, fluorine, a hydrocarbon group, an oxygen-containing hydrocarbon group, a fluorinated hydrocarbon group, or the fluorine-containing group represented by Formula (30),
each of R45, R46, and R52 is any of a hydrocarbon group, a fluorinated hydrocarbon group, or the fluorine-containing group represented by Formula (30),
each of R47 to R51 is any of hydrogen, fluorine, an alkyl group, an alkoxy group, or a fluorinated alkyl group,
at least one of R39 to R44 is the fluorine-containing group,
at least one of R45 or R46 is the fluorine-containing group represented by Formula (30) wherein R201, R202, R204 and R205 is hydrogen and R203 is a trifluoromethyl group, and
at least one of R47 to R51 is a trifluoromethyl group, 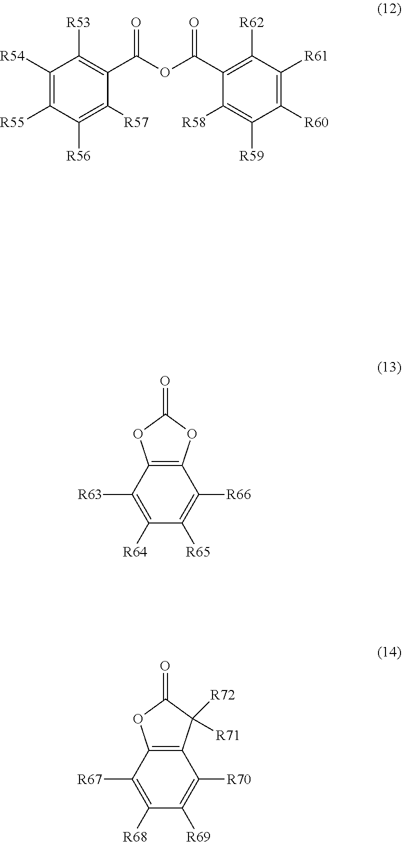
where
each of R53 to R70 is any of hydrogen, fluorine, an alkyl group, an alkoxy group, or a fluorinated alkyl group,
each of R71 and R72 is any of hydrogen, fluorine, a hydrocarbon group, an oxygen-containing hydrocarbon group, a fluorinated hydrocarbon group, or the fluorine-containing group represented by Formula (30),
at least one of R53 to R62 is a trifluoromethyl group,
at least one of R63 to R66 is a trifluoromethyl group, and
at least one of R67 to R70 is a trifluoromethyl group, 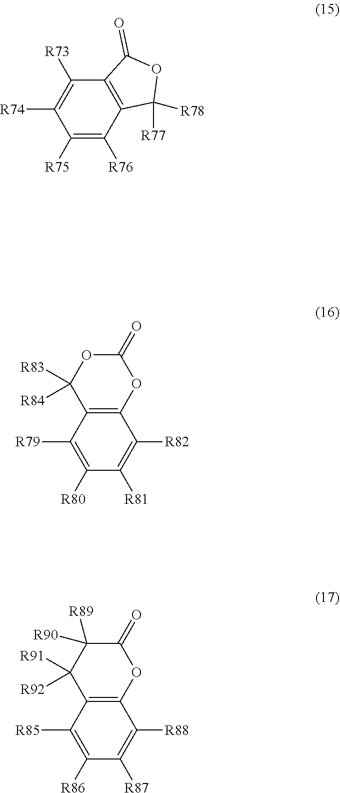
where
each of R73 to R76, R79 to R82, and R85 to R88 is any of hydrogen, fluorine, an alkyl group, an alkoxy group, or a fluorinated alkyl group,
each of R77, R78, R83, R84, and R89 to R92 is any of hydrogen, fluorine, a hydrocarbon group, an oxygen-containing hydrocarbon group, a fluorinated hydrocarbon group, or the fluorine-containing group represented by Formula (30),
at least one of R73 to R76 is a trifluoromethyl group,
at least one of R79 to R82 is a trifluoromethyl group, and
at least one of R85 to R88 is a trifluoromethyl group, 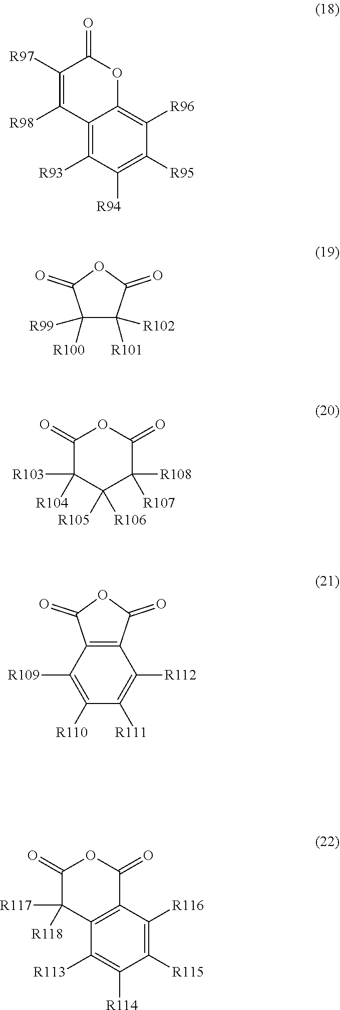
where
each of R93 to R96 and R109 to R116 is any of hydrogen, fluorine, an alkyl group, an alkoxy group, or a fluorinated alkyl group,
each of R97 to R108, R117, and R118 is any of hydrogen, fluorine, a hydrocarbon group, an oxygen-containing hydrocarbon group, a fluorinated hydrocarbon group, or the fluorine-containing group represented by Formula (30),
at least one of R93 to R96 is a trifluoromethyl group,
at least one of R99 to R102 is the fluorine-containing group,
at least one of R103 to R108 is the fluorine-containing group,
at least one of R109 to R112 is a trifluoromethyl group, and
at least one of R113 to R116 is a trifluoromethyl group, 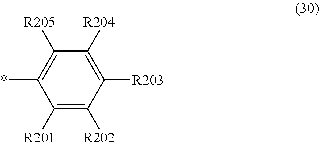
where
each of R201 to R205 is any of hydrogen or a trifluoromethyl group,
an asterisk (*) is a dangling bond, and
at least one of R201 to R205 is a trifluoromethyl group.

2. The secondary battery according to claim 1, wherein
the hydrocarbon group comprises any of an alkyl group, an alkenyl group, or an alkynyl group,
the oxygen-containing hydrocarbon group comprises an alkoxy group,
the fluorinated hydrocarbon group comprises a group resulting from substituting at least one hydrogen of the hydrocarbon group with at least one fluorine, and
carbon number of each of the alkyl group, the alkenyl group, the alkynyl group, and the alkoxy group is less than or equal to 3.

3. The secondary battery according to claim 1, wherein
the fluorinated alkyl group comprises a group resulting from substituting at least one hydrogen of the alkyl group with at least one fluorine, and
carbon number of the alkyl group is less than or equal to 3.

4. The secondary battery according to claim 1, wherein a content of the fluorine-containing compound in the electrolytic solution is greater than or equal to 0.5 weight percent and less than or equal to 2.0 weight percent.

5. The secondary battery according to claim 1, wherein the electrolytic solution further includes at least one of an unsaturated cyclic carbonic acid ester, a fluorinated cyclic carbonic acid ester, or a cyanated cyclic carbonic acid ester.

6. The secondary battery according to claim 1, wherein the electrolytic solution further includes at least one of a sulfonic acid ester, a sulfuric acid ester, a sulfurous acid ester, a dicarboxylic acid anhydride, a disulfonic acid anhydride, or a sulfonic acid carboxylic acid anhydride.

7. The secondary battery according to claim 1, wherein the electrolytic solution further includes a nitrile compound.

8. The secondary battery according to claim 1, wherein the secondary battery comprises a lithium-ion secondary battery.

9. An electrolytic solution for a secondary battery, the electrolytic solution comprising a fluorine-containing compound, wherein
the fluorine-containing compound includes at least one of respective compounds represented by Formulae (1) to (22), 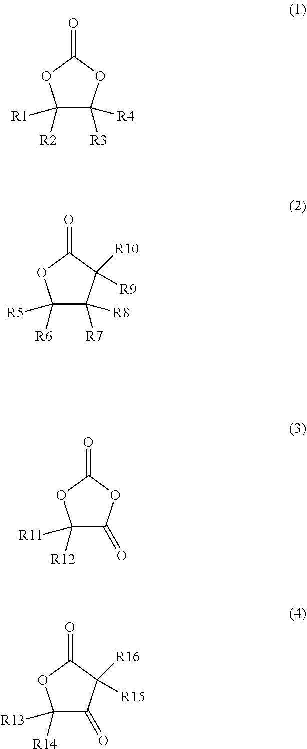
where
each of R1 to R16 is any of hydrogen, fluorine, a hydrocarbon group, an oxygen-containing hydrocarbon group, a fluorinated hydrocarbon group, or a fluorine-containing group represented by Formula (30),
at least one of R1 to R4 is the fluorine-containing group represented by Formula (30),
at least one of R5 to R10 is the fluorine-containing group represented by Formula (30),
at least one of R11 or R12 is the fluorine-containing group, and
at least one of R13 to R16 is the fluorine-containing group, 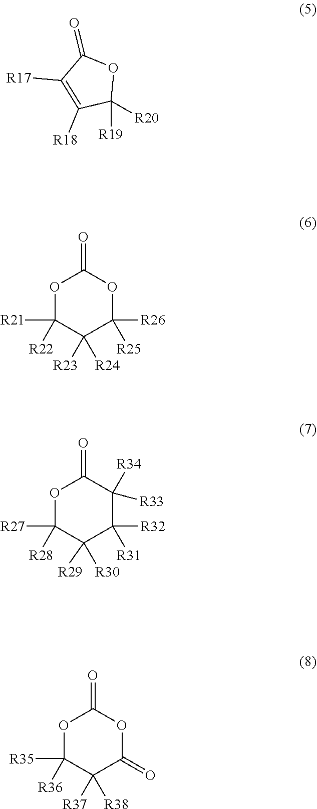
where
each of R17 to R38 is any of hydrogen, fluorine, a hydrocarbon group, an oxygen-containing hydrocarbon group, a fluorinated hydrocarbon group, or the fluorine-containing group represented by Formula (30),
at least one of R17 to R20 is the fluorine-containing group,
at least one of R21 to R26 is the fluorine-containing group,
at least one of R27 to R34 is the fluorine-containing group, and
at least one of R35 to R38 is the fluorine-containing group, 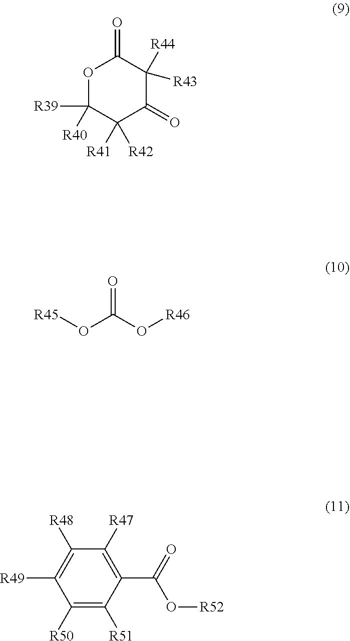
where
each of R39 to R44 is any of hydrogen, fluorine, a hydrocarbon group, an oxygen-containing hydrocarbon group, a fluorinated hydrocarbon group, or the fluorine-containing group represented by Formula (30),
each of R45, R46, and R52 is any of a hydrocarbon group, a fluorinated hydrocarbon group, or the fluorine-containing group represented by Formula (30),
each of R47 to R51 is any of hydrogen, fluorine, an alkyl group, an alkoxy group, or a fluorinated alkyl group,
at least one of R39 to R44 is the fluorine-containing group,
at least one of R45 or R46 is the fluorine-containing group represented by Formula (30) wherein R201, R202, R204 and R205 is hydrogen and R203 is a trifluoromethyl group, and
at least one of R47 to R51 is a trifluoromethyl group, 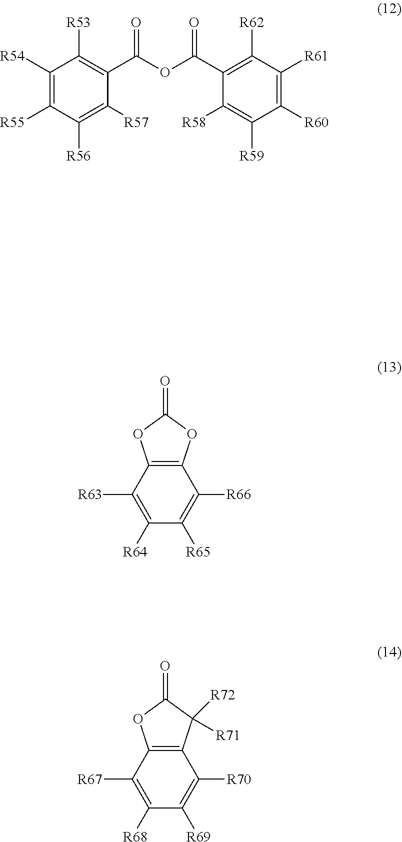
where
each of R53 to R70 is any of hydrogen, fluorine, an alkyl group, an alkoxy group, or a fluorinated alkyl group,
each of R71 and R72 is any of hydrogen, fluorine, a hydrocarbon group, an oxygen-containing hydrocarbon group, a fluorinated hydrocarbon group, or the fluorine-containing group represented by Formula (30),
at least one of R53 to R62 is a trifluoromethyl group,
at least one of R63 to R66 is a trifluoromethyl group, and
at least one of R67 to R70 is a trifluoromethyl group, 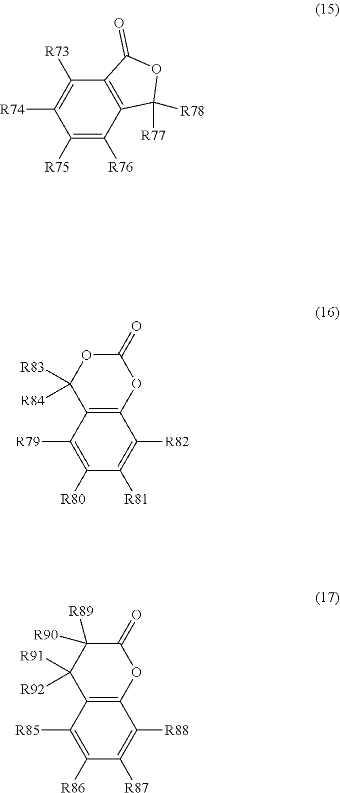
where
each of R73 to R76, R79 to R82, and R85 to R88 is any of hydrogen, fluorine, an alkyl group, an alkoxy group, or a fluorinated alkyl group,
each of R77, R78, R83, R84, and R89 to R92 is any of hydrogen, fluorine, a hydrocarbon group, an oxygen-containing hydrocarbon group, a fluorinated hydrocarbon group, or the fluorine-containing group represented by Formula (30),
at least one of R73 to R76 is a trifluoromethyl group,
at least one of R79 to R82 is a trifluoromethyl group, and
at least one of R85 to R88 is a trifluoromethyl group, 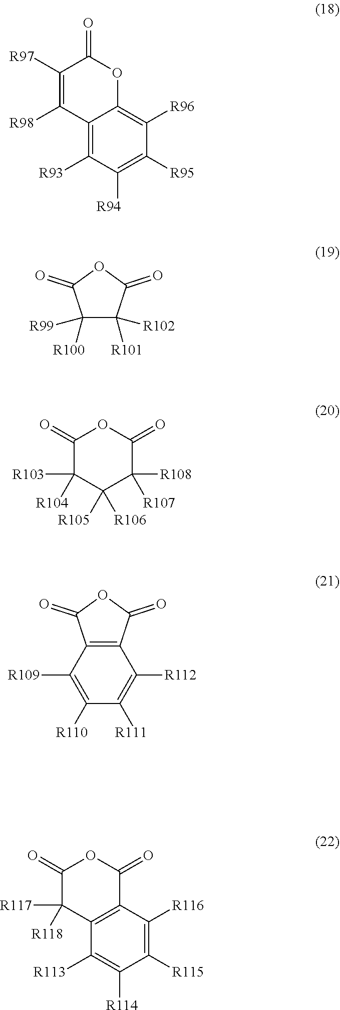
where
each of R93 to R96 and R109 to R116 is any of hydrogen, fluorine, an alkyl group, an alkoxy group, or a fluorinated alkyl group,
each of R97 to R108, R117, and R118 is any of hydrogen, fluorine, a hydrocarbon group, an oxygen-containing hydrocarbon group, a fluorinated hydrocarbon group, or the fluorine-containing group represented by Formula (30),
at least one of R93 to R96 is a trifluoromethyl group,
at least one of R99 to R102 is the fluorine-containing group,
at least one of R103 to R108 is the fluorine-containing group,
at least one of R109 to R112 is a trifluoromethyl group, and
at least one of R113 to R116 is a trifluoromethyl group, 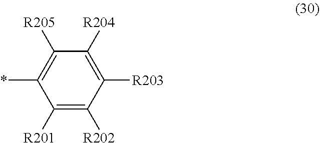
where
each of R201 to R205 is any of hydrogen or a trifluoromethyl group,
an asterisk (*) is a dangling bond, and
at least one of R201 to R205 is a trifluoromethyl group.

10. The secondary battery according to claim 1, wherein
at least one of R11 or R12 is the fluorine-containing group represented by Formula (30),
at least one of R13 to R16 is the fluorine-containing group represented by Formula (30),
at least one of R17 to R20 is the fluorine-containing group represented by Formula (30),
at least one of R21 to R26 is the fluorine-containing group represented by Formula (30),
at least one of R27 to R34 is the fluorine-containing group represented by Formula (30),
at least one of R35 to R38 is the fluorine-containing group represented by Formula (30),
at least one of R39 to R44 is the fluorine-containing group represented by Formula (30), and
at least one of R103 to R108 is the fluorine-containing group represented by Formula (30).

11. The secondary battery according to claim 1, wherein
the fluorine-containing compound includes at least one of respective compounds represented by Formula (13) to (18), (21) and (22).
